(19) United States
(12) Patent Application Publication
(10) Pub. No.: US 2025/0067923 A1
(43) Pub. Date: Feb. 27, 2025

(54) ILLUMINATION DEVICE AND DISPLAY DEVICE

(71) Applicant: Sharp Display Technology Corporation, Kameyama city (JP)

(72) Inventors: Shugo YAGI, Kameyama City (JP); Junichi MASUDA, Kameyama City (JP); Yuuichi KANBAYASHI, KameyamaCity (JP); Satoshi TSUBOOKA, KameyamaCity (JP)

(21) Appl. No.: 18/777,605

(22) Filed: Jul. 19, 2024

(30) Foreign Application Priority Data
Aug. 22, 2023 (JP) 2023-134612

(51) Int. Cl. F21V 8/00

(52) U.S. Cl. CPC G02B 6/0076; G02B 6/0036; G02B 6/005; G02B 6/0068

(57) ABSTRACT

An illumination device includes a first light source, a first light guide plate, a first sheet, a second light source, and a second light guide plate. The first sheet at least includes two first light blocking portions, and a first light-transmitting portion. A second opposite main surface of the second light guide plate includes a first inclined surface and a second inclined surface. The first inclined surface has an inclination rising from a side opposite to a second LED toward the second LED side in the first direction. An angle of the first inclined surface with respect to the first direction is a first angle that is greater than 27°, and an angle of the second inclined surface with respect to the first direction is a second angle that is greater than the first angle and smaller than 58°.

### CROSS-REFERENCE TO RELATED APPLICATIONS

This application claims the benefit of priority to Japanese Patent Application Number 2023-134612 filed on Aug. 22, 2023. The entire contents of the above-identified application are hereby incorporated by reference.

### BACKGROUND

### Technical Field

The techniques disclosed in the present specification relate to illumination devices and display devices.

An illumination device described in US 2017/0069236 A is known as an example of an illumination device in related art. The illumination device described in US 2017/0069236 A operates in at least two operation modes, that is, a free viewing mode and a restricted viewing mode. The illumination device includes a backlight system. A light guide plate is disposed in front of the backlight system, and a light source is disposed along a side surface of the light guide plate. The light guide plate includes diffusion particles, formed of a polymer, dispersed and mixed in a resin base material, and has a light transmittance of at least 80%. In the free viewing mode, the light source is turned on, and the backlight system is turned off. In the restricted viewing mode, the backlight system is turned on, and the light source is turned off.

### SUMMARY

Since the light guide plate provided in the illumination device described in US 2017/0069236 A described above contains the diffusion particles, light emitted from the backlight system and incident on the light guide plate is diffused by the diffusion particles in the restricted viewing mode. Thus, there is a problem that emission of light outside an angle range restricted in the restricted viewing mode is likely to occur, and this makes it difficult to emit light only in the restricted angle range. In addition, since the light guide plate has a high light transmittance of at least 80%, light from the light source is not sufficiently diffused in a process of transmitting through the light guide plate in the free viewing mode. Thus, there is a problem that brightness of emission light in a direction inclined with respect to a front direction is insufficient in the free viewing mode.

The techniques described in the present specification are made based on the circumstances described above, and an object thereof is to suppress emission of light outside a restricted angle range, and to improve brightness of emission light in a direction inclined with respect to a front direction.
(1) An illumination device related to the techniques described in the present specification includes a first light source, a first light guide plate, at least a part of an outer peripheral end surface of the first light guide plate being a first end surface facing the first light source and on which light is incident, one of main surfaces of the first light guide plate being a first main surface configured to emit light and the other of the main surfaces being a second main surface, a first sheet, one of main surfaces of the first sheet being a third main surface facing the first main surface and on which light is incident, and the other of the main surfaces being a fourth main surface configured to emit light, a second light source, and a second light guide plate, at least a part of an outer peripheral end surface of the second light guide plate being a second end surface facing the second light source and on which light is incident, one of main surfaces of the second light guide plate being a fifth main surface configured to emit light, and the other of the main surfaces being a sixth main surface disposed facing the fourth main surface. The first sheet at least includes two first light blocking portions and a first light-transmitting portion. The two first light blocking portions are disposed with an interval therebetween in a first direction including a direction from the first light source toward the first light guide plate and are configured to block light. The first light-transmitting portion is disposed between the two first light blocking portions and configured to transmit light. The sixth main surface of the second light guide plate includes a first inclined surface and a second inclined surface. The first inclined surface and the second inclined surface have an inclination rising from a side opposite to a side of the second light source toward the side of the second light source in the first direction. An angle of the first inclined surface with respect to the first direction is a first angle greater than 27°, and an angle of the second inclined surface with respect to the first direction is a second angle greater than the first angle and smaller than 58°.
(2) In the illumination device described above, in addition to (1) described above, the sixth main surface of the second light guide plate may include a third inclined surface having an inclination rising from the side of the second light source toward the side opposite to the side of the second light source in the first direction.
(3) In the illumination device described above, in addition to (2) described above, the third inclined surface may include a fourth inclined surface disposed facing the second inclined surface with an interval therebetween, and an angle of the fourth inclined surface with respect to the first direction may be a third angle equal to or greater than 40°.
(4) In the illumination device described above, in addition to (3) described above, the third angle of the fourth inclined surface may be equal to or greater than 65°.
(5) In the illumination device described above, in addition to (3) described above, the third angle of the fourth inclined surface may be equal to or greater than 67°.
(6) In the illumination device described above, in addition to any one of (2) to (5) described above, the third inclined surface may include a fourth inclined surface disposed facing the second inclined surface with an interval therebetween and a fifth inclined surface disposed facing the first inclined surface with an interval therebetween, and an angle of the fifth inclined surface with respect to the first direction may be a fourth angle equal to a third angle, the third angle being an angle of the fourth inclined surface with respect to the first direction.
(7) In the illumination device described above, in addition to any one of (2) to (5) described above, the third inclined surface may include a fourth inclined surface disposed facing the second inclined surface with an interval therebetween and a fifth inclined surface disposed facing the first inclined surface with an interval therebetween, and an angle of the fifth inclined surface with respect to the first direction may be a fourth angle smaller than a third angle, the third angle being an angle of the fourth inclined surface with respect to the first direction.
(8) In the illumination device described above, in addition to (7) described above, the first inclined surface and the fourth inclined surface may be disposed with an interval therebetween in the first direction, the third inclined surface may include a sixth inclined surface located between the first inclined surface and the fourth inclined surface, and an angle of the sixth inclined surface with respect to the first direction may be a fifth angle equal to the fourth angle.
(9) A display device related to the techniques described in the present specification includes the illumination device described in any one of (1) to (8) described above, and a display panel configured to perform display using light from the illumination device.

The techniques described herein can suppress emission of light outside a restricted angle range, and can improve brightness of emission light in a direction inclined with respect to a front direction.

### BRIEF DESCRIPTION OF DRAWINGS

The disclosure will be described with reference to the accompanying drawings, wherein like numbers reference like elements.

FIG. 1 is a side cross-sectional view of a liquid crystal display device according to a first embodiment.

FIG. 2 is a side cross-sectional view of a backlight device provided in the liquid crystal display device according to the first embodiment.

FIG. 3 is a front cross-sectional view of the backlight device according to the first embodiment.

FIG. 4 is a perspective view when a first light guide plate constituting the backlight device according to the first embodiment is viewed from a first opposite main surface side.

FIG. 5 is a bottom view illustrating a configuration of the first opposite main surface of the first light guide plate according to the first embodiment.

FIG. 6 is a side cross-sectional view of a second light guide plate constituting the backlight device according to the first embodiment.

FIG. 7 is a bottom view illustrating a configuration of a second opposite main surface of the second light guide plate according to the first embodiment.

FIG. 8 is a graph showing a relationship between a position, in an X-axis direction, of the second light guide plate according to the first embodiment, and each of a width dimension of a first inclined surface, a width dimension of a fourth inclined surface, a width dimension of a third plane, a width dimension of a second inclined surface, and a width dimension of a fifth inclined surface.

FIG. 9 is a graph showing a relationship between the position, in the X-axis direction, of the second light guide plate according to the first embodiment, and each of a height dimension of a sixth light guide plate lens and a height dimension of a seventh light guide plate lens.

FIG. 10 is a graph showing light distribution when the first inclined surface and the second inclined surface are changed in Demonstration Experiment 1 according to the first embodiment.

FIG. 11 is a graph showing light distribution when a first LED is turned on and a second LED is turned off in Comparative Example 1 of Comparative Experiment 1 according to the first embodiment.

FIG. 12 is a graph showing light distribution when the second LED is turned on and the first LED is turned off in Comparative Example 1 of Comparative Experiment 1 according to the first embodiment.

FIG. 13 is a graph showing light distribution when both of the first LED and the second LED are turned on in Comparative Example 1 of Comparative Experiment 1 according to the first embodiment.

FIG. 14 is a graph showing light distribution when the first LED is turned on and the second LED is turned off in Example 1 of Comparative Experiment 1 according to the first embodiment.

FIG. 15 is a graph showing light distribution when the second LED is turned on and the first LED is turned off in Example 1 of Comparative Experiment 1 according to the first embodiment.

FIG. 16 is a graph showing light distribution when both of the first LED and the second LED are turned on in Example 1 of Comparative Experiment 1 according to the first embodiment.

FIG. 17 is a diagram for describing angles in the X-axis direction with respect to a front direction in the liquid crystal display device installed in front of a front passenger seat of a passenger vehicle according to the first embodiment.

FIG. 18 is a side cross-sectional view of a second light guide plate according to a second embodiment.

FIG. 19 is a graph showing light distribution when the fourth inclined surface and the fifth inclined surface are changed in Demonstration Experiment 2 according to the second embodiment.

FIG. 20 is a graph showing light distribution when the first LED is turned on and the second LED is turned off in Example 2 of Comparative Experiment 2 according to the second embodiment.

FIG. 21 is a graph showing light distribution when the second LED is turned on and the first LED is turned off in Example 2 of Comparative Experiment 2 according to the second embodiment.

FIG. 22 is a graph showing light distribution when both of the first LED and the second LED are turned on in Example 2 of Comparative Experiment 2 according to the second embodiment.

FIG. 23 is a side cross-sectional view of a second light guide plate according to a third embodiment.

FIG. 24 is a front cross-sectional view of the second light guide plate according to the third embodiment.

FIG. 25 is a graph showing light distribution when the fourth inclined surface is changed in Demonstration Experiment 3 according to the third embodiment.

FIG. 26 is a graph obtained by enlarging a part of FIG. 25 in Demonstration Experiment 3 according to the third embodiment.

FIG. 27 is a table showing experimental results of Demonstration Experiment 3 according to the third embodiment.

FIG. 28 is a graph showing light distribution when the first LED is turned on and the second LED is turned off in Example 3 of Comparative Experiment 3 according to the third embodiment.

FIG. 29 is a graph showing light distribution when the second LED is turned on and the first LED is turned off in Example 3 of Comparative Experiment 3 according to the third embodiment.

FIG. 30 is a graph showing light distribution when both of the first LED and the second LED are turned on in Example 3 of Comparative Experiment 3 according to the third embodiment.

### DESCRIPTION OF EMBODIMENTS

### First Embodiment

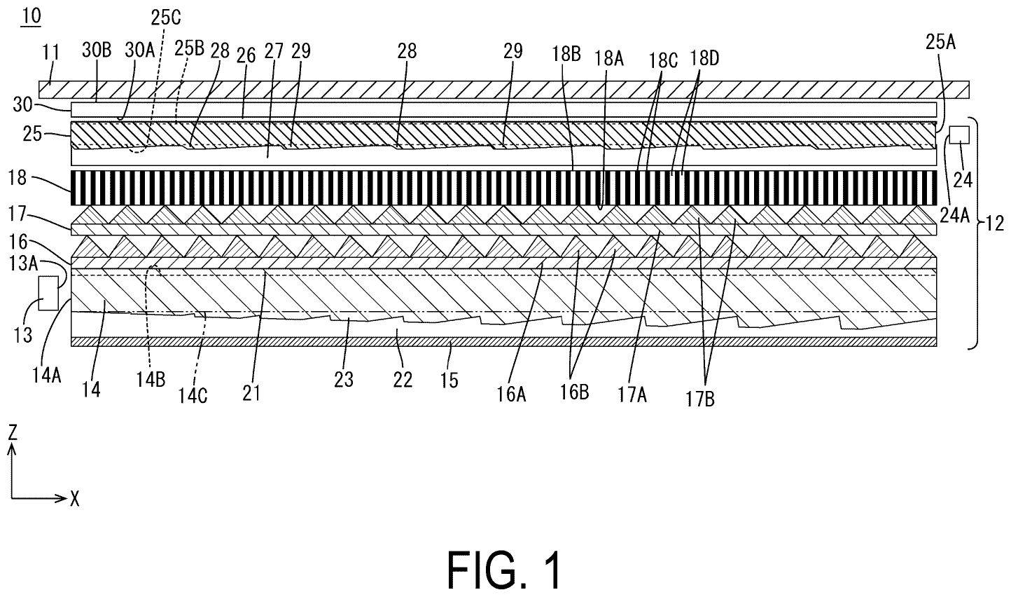

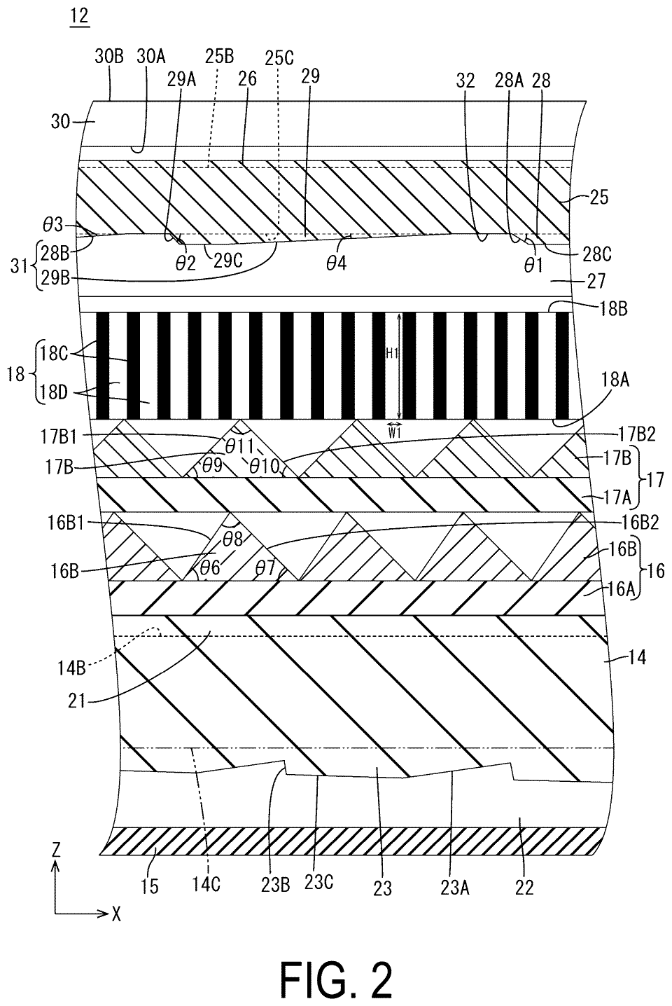

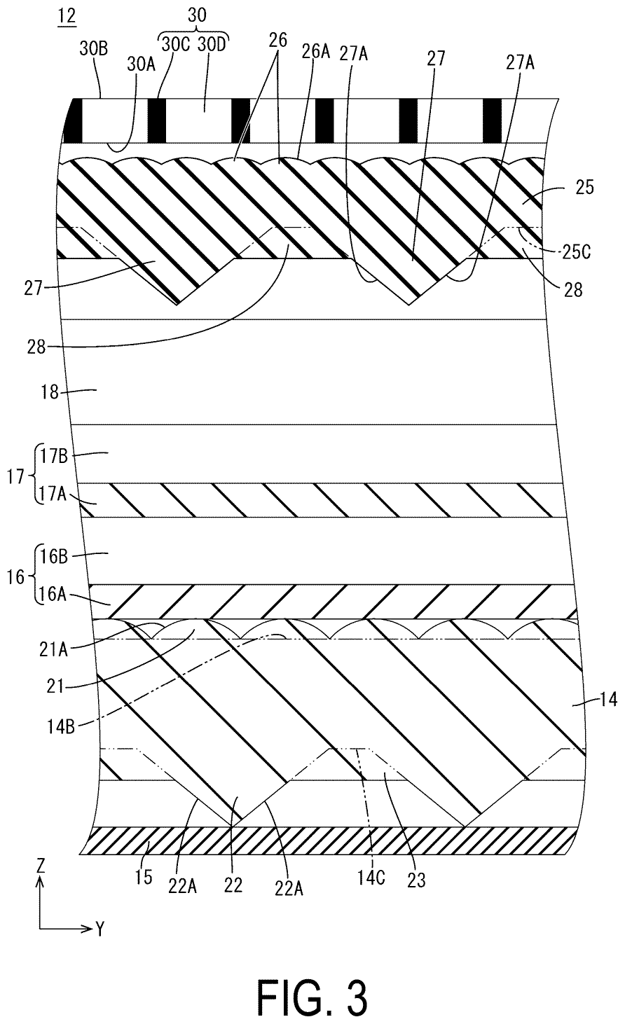

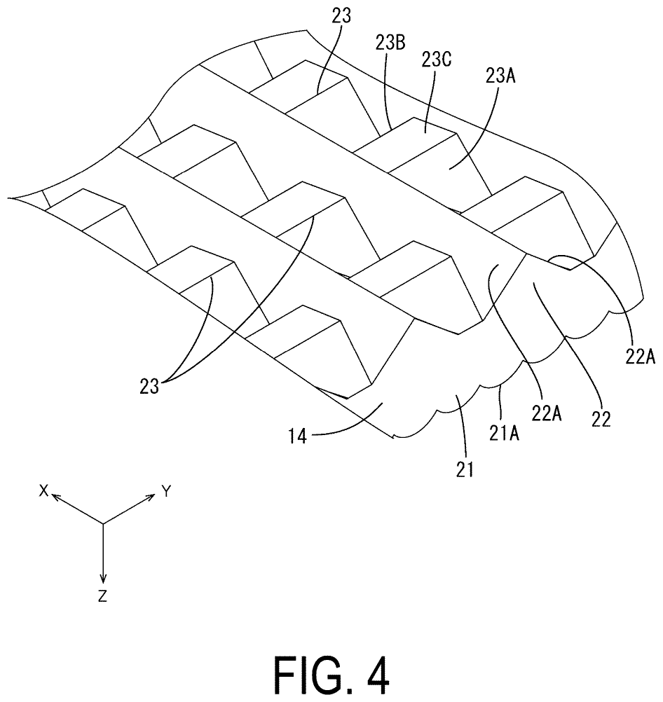

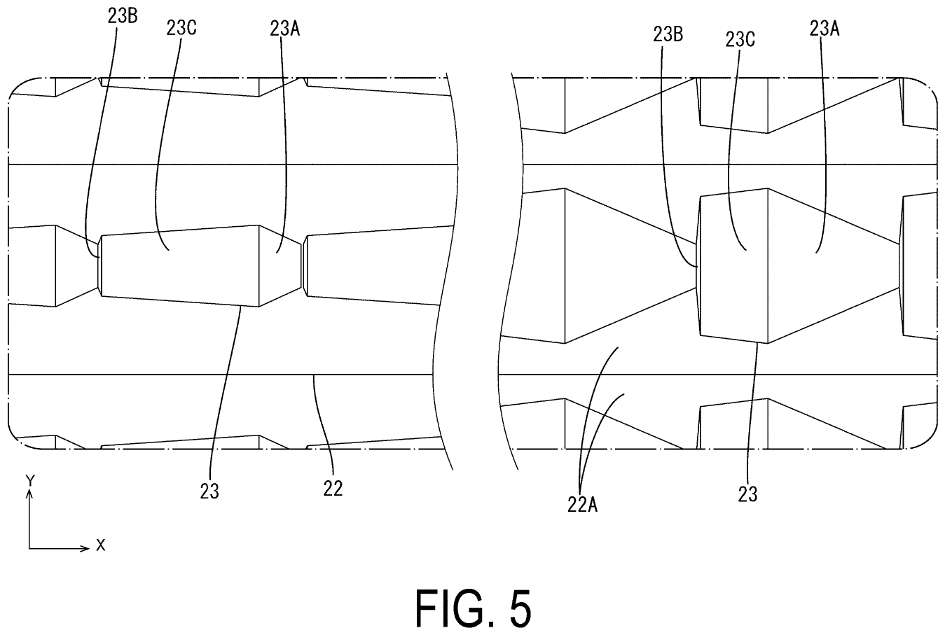

A first embodiment will be described with reference to FIGS. 1 to 17. In the present embodiment, a liquid crystal display device (display device) 10 will be exemplified. Note that some drawings show an X-axis, a Y-axis, and a Z-axis, and directions of these axes are drawn so as to be common in all the drawings. Further, a vertical direction is based on the vertical direction of FIG. 2 and FIG. 3, the upper side of the same drawing is referred to as a front side, and the lower side of the same drawing is referred to as a back side.

As illustrated in FIG. 1, the liquid crystal display device 10 includes a liquid crystal panel (display panel) 11 that displays an image, and a backlight device (illumination device) 12 that is disposed on the back side of the liquid crystal panel 11 and irradiates the liquid crystal panel 11 with light to be used for display. In the present embodiment, the liquid crystal display device 10 for vehicle application will be exemplified. For example, the liquid crystal display device 10 for vehicle application is mounted on a car navigation system displaying a map and the like as an image, a multi-function display displaying an operation situation and the like of equipment such as an air conditioner in addition to a map and the like as an image, an instrument panel displaying gauges, alerts, and the like as an image, and an infotainment system displaying television images, audio information, and the like in addition to a map and the like as an image.

The liquid crystal panel 11 has a plate shape in which a main surface is parallel to the X-axis direction and the Y-axis direction, and a normal direction (thickness direction) of the main surface coincides with the Z-axis direction. In the liquid crystal panel 11, a central side portion of the main surface is a display region that can display an image, and an outer circumferential end side portion surrounding the display region and having a frame shape is a non-display region. The liquid crystal panel 11 includes a pair of substrates and a liquid crystal layer sealed between the pair of substrates. Of the pair of substrates constituting the liquid crystal panel 11, the one disposed on the front side is a CF substrate (counter substrate), and the one disposed on the back side is an array substrate (TFT substrate). Color filters that exhibit red (R), green (G), blue (B), and the like, a light blocking portion (black matrix) that partitions adjacent color filters, and the like are provided on the CF substrate. The array substrate (TFT substrate) is provided with at least a gate wiring line and a source wiring line that are orthogonal to each other, a switching element (for example, a TFT) connected to the gate wiring line and the source wiring line, and a pixel electrode connected to the switching element and constituting a pixel. Note that an alignment film is provided on each inner surface of the array substrate and the CF substrate constituting the liquid crystal panel 11. Further, a polarizer is attached to each outer surface of the array substrate and the CF substrate constituting the liquid crystal panel 11.

Next, the backlight device 12 will be described. As illustrated in FIG. 1, the backlight device 12 includes at least a first LED (first light source) 13, a first light guide plate 14 that guides light from the first LED 13, a reflection sheet 15 disposed on the back side (opposite light emission side) of the first light guide plate 14, a first prism sheet 16 disposed on the front side (light emission side) of the first light guide plate 14, and a second prism sheet 17 disposed on the front side of the first prism sheet 16.

As illustrated in FIG. 1, the first LED 13 has a substantially block shape, and one surface of a pair of surfaces along the Y-axis direction and the Z-axis direction is a first light-emitting surface 13A that emits light. A plurality of the first LEDs 13 are disposed side by side at an interval along the Y-axis direction. The first LED 13 is mounted on an LED substrate. The first LED 13 has a configuration in which an LED chip is sealed with a sealing material on a substrate portion mounted on the LED substrate. The LED chip provided in the first LED 13 emits light of a single color, for example, blue light. A phosphor is dispersed and mixed in the sealing material provided in the first LED 13. The phosphor contained in the sealing material includes a yellow phosphor, a green phosphor, a red phosphor, and the like. The first LED 13 including such an LED chip and such a sealing material emits white light as a whole.

The first light guide plate 14 is formed of a synthetic resin material (for example, an acrylic resin such as PMMA or the like) that has a sufficiently higher refractive index than that of the air and that is substantially transparent. As illustrated in FIG. 1, the first light guide plate 14 has a plate shape, and a main surface of the first light guide plate 14 is parallel to the main surface of the liquid crystal panel 11. Note that the main surface of the first light guide plate 14 is parallel to the X-axis direction and the Y-axis direction, and a normal direction (thickness direction) of the main surface coincides with the Z-axis direction. The first light guide plates 14 are arranged side by side along the X-axis direction (first direction) with respect to the first LED 13, and are also disposed side by side along the Z-axis direction with respect to the liquid crystal panel 11 and each of the prism sheets 16 and 17. The first light guide plate 14 is disposed on one side (right side in FIG. 1) of the first LED 13 in the X-axis direction. One end surface of an outer peripheral end surface of the first light guide plate 14 is a first light incident end surface (first end surface) 14A facing the first light-emitting surface 13A of the first LED 13. The first light incident end surface 14A is a surface parallel to the first light-emitting surface 13A of the first LED 13, and light emitted from the first light-emitting surface 13A is incident on the first light incident end surface 14A. Therefore, it can be said that the first LED 13 is disposed only on one side of the first light guide plate 14 in the X-axis direction, and the first light guide plate 14, together with the first LED 13, constitutes a backlight unit of a one-side light incident type. Of a pair of main surfaces of the first light guide plate 14, the main surface on the front side facing the first prism sheet 16 is a first light guide plate light emission main surface (first main surface) 14B that emits light that has been guided through the inside of the first light guide plate 14. Of the pair of main surfaces of the first light guide plate 14, the main surface on the back side facing the reflection sheet 15 is a first opposite main surface (second main surface) 14C located on the side opposite to the first light guide plate light emission main surface 14B. Then, the first light guide plate 14 has a function of introducing, from the first light incident end surface 14A, light emitted from the first LED 13 toward the first light guide plate 14, propagating the light thereinside, then, causing the light to rise along the Z-axis direction such that the light is directed toward the front side (light emission side), and emitting the light. A detailed structure of the first light guide plate 14 will be described later. Note that the normal direction of the first light incident end surface 14A coincides with the X-axis direction (an arrangement direction of the first LED 13 and the first light guide plate 14).

As illustrated in FIG. 1, the reflection sheet 15 has a main surface parallel to each of the main surfaces of the liquid crystal panel 11 and the first light guide plate 14, and is also disposed so as to cover the first opposite main surface 14C of the first light guide plate 14. The reflection sheet 15 has excellent light reflectivity, and can efficiently cause light leaked from the first opposite main surface 14C of the first light guide plate 14 to rise toward the front side, that is, toward the first light guide plate light emission main surface 14B. The reflection sheet 15 has an outer shape slightly larger than that of the first light guide plate 14, and is disposed so as to overlap the substantially entire region of the first opposite main surface 14C.

As illustrated in FIG. 1, the first prism sheet 16 and the second prism sheet 17 have a sheet shape, and each main surface thereof is parallel to each of the main surfaces of the liquid crystal panel 11 and the first light guide plate 14. Note that the main surfaces of the first prism sheet 16 and the second prism sheet 17 are parallel to the X-axis direction and the Y-axis direction, and a normal direction (thickness direction) of the main surface coincides with the Z-axis direction. The first prism sheet 16 and the second prism sheet 17 are layered on the front side of the first light guide plate 14, and have a function of providing a predetermined optical action to light emitted from the first light guide plate light emission main surface 14B of the first light guide plate 14 before emitting the light, and the like.

As illustrated in FIG. 1, the first prism sheet 16 includes a first base material 16A having a sheet shape, and a first prism 16B provided on a main surface (light emission main surface) on the front side (light emission side) of the first base material 16A. The first base material 16A is formed of a substantially transparent synthetic resin, and specifically, is formed of, for example, a crystalline transparent resin material such as polyethylene terephthalate (PET). The first base material 16A is formed into a sheet shape by stretching the crystalline transparent resin material serving as a raw material in a biaxially stretching process in manufacturing, which is suitable for reducing manufacturing costs. The first prism 16B is formed of an ultraviolet-curing resin material that is substantially transparent and is a type of a photo-curable resin material. When manufacturing the first prism sheet 16, for example, an uncured ultraviolet-curing resin material is filled into a mold for molding, and the first base material 16A is also applied to an opening end of the mold to dispose the uncured ultraviolet-curing resin material so as to contact the main surface on the front side, and in this state, when the ultraviolet-curing resin material is irradiated with ultraviolet rays through the first base material 16A, the ultraviolet-curing resin material is cured, and the first prism 16B is integrally provided with the first base material 16A. The ultraviolet-curing resin material constituting the first prism 16B is, for example, an acrylic resin such as PMMA. A refractive index of the ultraviolet-curing resin material constituting the first prism 16B is preferably set in a range from 1.49 to 1.52, and is most preferably set to 1.49.

As illustrated in FIG. 2, the first prism 16B is provided so as to protrude from the main surface of the first base material 16A toward the front side (the side opposite to the first light guide plate 14 side) along the Z-axis direction. The first prism 16B has a substantially triangular shape (is substantially mountain-shaped) in a cross section taken along the X-axis direction and also extends linearly along the Y-axis direction (second direction), and a plurality of the first prisms 16B are continuously disposed side by side with substantially no interval along the X-axis direction (first direction) on the main surface of the first base material 16A. The first prism 16B includes a pair of inclined surfaces 16B1 and 16B2. Of the pair of inclined surfaces 16B1 and 16B2 of the first prism 16B, the inclined surface on the first LED 13 side in the X-axis direction is a first prism inclined surface 16B1, and the inclined surface on the side opposite to the first LED 13 side is a second prism inclined surface 16B2. The first prism inclined surface 16B1 has an inclination rising from the first LED 13 side (left side in FIG. 2) in the first prism sheet 16 toward the side opposite (right side in FIG. 2) to the first LED 13 side in the X-axis direction. Of light incident on the first prism 16B, mainly light traveling in a direction approaching the first LED 13 in the X-axis direction is incident on and refracted by the first prism inclined surface 16B1. The second prism inclined surface 16B2 has an inclination rising from the side opposite (right side in FIG. 2) to the first LED 13 side in the first prism sheet 16 toward the first LED 13 side (left side in FIG. 2) in the X-axis direction. Of the light incident on the first prism 16B, mainly light traveling in a direction moving away from the first LED 13 in the X-axis direction is incident on and refracted by the second prism inclined surface 16B2. Most of the light refracted by the pair of inclined surfaces 16B1 and 16B2 in the first prism 16B is selectively raised and condensed in the X-axis direction.

Then, as illustrated in FIG. 2, in the first prism 16B, when comparing an inclination angle (third base angle) 06 formed by the first prism inclined surface 16B1 with respect to the X-axis direction, and an inclination angle (fourth base angle) 07 formed by the second prism inclined surface 16B2 with respect to the X-axis direction, the former is greater than the latter. In other words, the first prism 16B has an asymmetrical cross-sectional shape, which is a scalene triangle. Specifically, the inclination angle θ6 of the first prism inclined surface 16B1 with respect to the X-axis direction is preferably set in a range from 50° to 60°, and is most preferably set to 55°. In contrast, the inclination angle θ7 of the second prism inclined surface 16B2 with respect to the X-axis direction is preferably set in a range from 35° to 50°, and is most preferably set to 45°. Further, an angle (second apex angle) 08 formed by the pair of inclined surfaces 16B1 and 16B2 in the first prism 16B is preferably set in a range from 70° to 95°, and is most preferably set to 80°. Note that all the plurality of first prisms 16B arranged side by side along the Y-axis direction have substantially the same height dimension, substantially the same width dimension, substantially the same inclination angle, and the like of each of the inclined surfaces 16B1 and 16B2 with respect to the X-axis direction, and are also arrayed such that array intervals between the first prisms 16B adjacent to each other are substantially constant and equal.

As illustrated in FIG. 1, the second prism sheet 17 includes a second base material 17A having a sheet shape, and a second prism 17B provided on a main surface (light emission main surface) on the front side (light emission side) of the second base material 17A. The second base material 17A is formed of a substantially transparent synthetic resin, and specifically, is formed of, for example, a crystalline transparent resin material such as PET, which is the same as that of the first base material 16A. The second prism 17B is formed of an ultraviolet-curing resin material that is substantially transparent and is a type of the photo-curable resin material. A manufacturing method of the second prism sheet 17 is similar to a manufacturing method of the first prism sheet 16 described above. The ultraviolet-curing resin material constituting the second prism 17B is, for example, an acrylic resin such as PMMA, and a refractive index of the ultraviolet-curing resin material is set higher than the refractive index of the material of the first prism 16B, and is set to, for example, approximately 1.61.

As illustrated in FIG. 2, the second prism 17B is provided so as to protrude from the main surface of the second base material 17A toward the front side (the side opposite to the first prism sheet 16 side) along the Z-axis direction. The second prism 17B has a substantially triangular shape (is substantially mountain-shaped) in a cross section taken along the X-axis direction and also extends linearly along the Y-axis direction, and a plurality of the second prisms 17B are continuously disposed side by side with substantially no interval along the X-axis direction on the main surface of the second base material 17A. The second prism 17B includes a pair of inclined surfaces 17B1 and 17B2. Of the pair of inclined surfaces 17B1 and 17B2 in the second prism 17B, the inclined surface on the first LED 13 side in the X-axis direction is a third prism inclined surface 17B1, and the inclined surface on the side opposite to the third prism inclined surface 17B1 is a fourth prism inclined surface 17B2. The third prism inclined surface 17B1 has an inclination rising from the first LED 13 side (left side in FIG. 2) in the second prism sheet 17 toward the side opposite (right side in FIG. 2) to the first LED 13 side in the X-axis direction. Of light incident on the second prism 17B, mainly light traveling in the direction approaching the first LED 13 in the X-axis direction is incident on and refracted by the third prism inclined surface 17B1. The fourth prism inclined surface 17B2 has an inclination rising from the side opposite (right side in FIG. 2) to the first LED 13 side in the second prism sheet 17 toward the first LED 13 side (left side in FIG. 2) in the X-axis direction. Of the light incident on the second prism 17B, mainly light traveling in the direction moving away from the first LED 13 in the X-axis direction is incident on and refracted by the fourth prism inclined surface 17B2. Most of the light refracted by the pair of inclined surfaces 17B1 and 17B2 in the second prism 17B is selectively raised and condensed in the X-axis direction.

Then, as illustrated in FIG. 2, in the second prism 17B, an inclination angle (fifth base angle) θ9 formed by the third prism inclined surface 17B1 with respect to the X-axis direction, and an inclination angle (sixth base angle) θ10 formed by the fourth prism inclined surface 17B2 with respect to the X-axis direction are the same. In other words, the second prism 17B has a symmetric cross-sectional shape, which is an isosceles triangle. Moreover, the respective inclination angles θ9 and θ10 of the third prism inclined surface 17B1 and the fourth prism inclined surface 17B2 with respect to the X-axis direction are smaller than the inclination angle θ6 of the first prism inclined surface 16B1 with respect to the X-axis direction. Specifically, the respective inclination angles θ9 and θ10 of the third prism inclined surface 17B1 and the fourth prism inclined surface 17B2 with respect to the X-axis direction are preferably set in a range from 40° to 50°, and is most preferably set to 45°. In contrast, an angle (third apex angle) θ11 formed by the pair of inclined surfaces 17B1 and 17B2 in the second prism 17B is preferably set in a range from 80° to 100°, and is most preferably set to 90°, that is, the right angle. Note that all the plurality of second prisms 17B arranged side by side along the Y-axis direction have substantially the same height dimension, substantially the same width dimension, substantially the same inclination angle, and the like of each of the surfaces 17B1 and 17B2 with respect to the X-axis direction, and are also arrayed such that array intervals between the second prisms 17B adjacent to each other are substantially constant and equal. Further, it is preferable that the height dimension and the array interval in the second prism 17B differ from the height dimension and the array interval in the first prism 16B, respectively, in terms of suppressing an occurrence of interference fringes called moire.

The first prism sheet 16 and the second prism sheet 17 having the configuration described above can obtain the following actions and effects. In other words, most of the light emitted from the first light guide plate light emission main surface 14B of the first light guide plate 14 and incident on the first prism sheet 16 is incident on the second prism inclined surface 16B2 of the first prism 16B and refracted, and then, is raised and emitted, or is directed to the first prism inclined surface 16B1. Here, the first prism 16B has the inclination angle θ6 formed with respect to the X-axis direction greater than the inclination angle θ7 of the second prism 17B formed with respect to the X-axis direction. Thus, as compared to when the angles are the same or the magnitude relationship between the angles is reversed, the light incident on the first prism sheet 16 becomes less likely to be incident on the first prism inclined surface 16B1. When the incident light on the first prism sheet 16 is incident on the first prism inclined surface 16B1 of the first prism 16B, the light is not raised when the light is emitted from the first prism 16B, and the light tends to become more likely to be emitted as side lobe light (stray light). Therefore, when the incident light on the first prism sheet 16 becomes less likely to be directly incident on the first prism inclined surface 16B1 of the first prism 16B, an occurrence of the side lobe light is suppressed, and, as a result, light usage efficiency is improved.

Most of the light emitted from the first prism sheet 16 and incident on the second prism sheet 17 is incident on the fourth prism inclined surface 17B2 of the second prism 17B and refracted, and then, is raised and emitted, or is directed to the third prism inclined surface 17B1. Here, the second prism 17B has the inclination angle θ7 formed with respect to the X-axis direction smaller than the inclination angle θ6, of the first prism 16B, formed with respect to the X-axis direction. Thus, as compared to when the angles are the same or the magnitude relationship between the angles is reversed, the light refracted by the fourth prism inclined surface 17B2 and directed to the third prism inclined surface 17B1 is more likely to be returned to the first prism sheet 16 side by the third prism inclined surface 17B1. As a result, an amount of the light (hereinafter referred to as recursive light) returned from the second prism sheet 17 to the first prism sheet 16 side is increased. This recursive light reaches the second prism sheet 17 again by being reflected or the like inside the backlight device 12, and is raised and emitted by either of the pair of inclined surfaces 17B1 and 17B2 in the second prism 17B, and thus the light usage efficiency is improved. Since an optical path until the recursive light is emitted from the second prism sheet 17 is complicated, a rise angle provided by the second prism 17B is also diversified. As a result, viewing angle characteristics are improved. As described above, the viewing angle characteristics and brightness are improved.

Next, a detailed structure of the first light guide plate 14 will be described. As illustrated in FIGS. 2 and 3, a first light guide plate lens 21, a second light guide plate lens 22, and a third light guide plate lens 23 are provided on the first light guide plate 14. As illustrated in FIG. 3, the first light guide plate lens 21 is provided on the first light guide plate light emission main surface 14B of the first light guide plate 14. The first light guide plate lens 21 extends along the X-axis direction, and a plurality of the first light guide plate lenses 21 are disposed side by side along the Y-axis direction. In the present embodiment, the first light guide plate lens 21 is a so-called lenticular lens. The first light guide plate lens 21 has a convex shape protruding from the first light guide plate light emission main surface 14B to the front side. Specifically, the first light guide plate lens 21 has a semi-circular shape in a cross section taken along the Y-axis direction and a semi-cylindrical shape linearly extending along the X-axis direction, and a surface of the first light guide plate lens 21 is a first circular arc-shaped surface 21A. When an angle formed by a tangent line at a base end portion of the first circular arc-shaped surface 21A with respect to the Y-axis direction is defined as a “contact angle”, a contact angle of the first light guide plate lens 21 is, for example, approximately 62°. All the plurality of first light guide plate lenses 21 arranged side by side along the Y-axis direction have substantially the same contact angle, substantially the same width dimension (array interval), and substantially the same height dimension. In order to provide the first light guide plate lens 21 having such a configuration integrally with the first light guide plate 14, for example, the first light guide plate 14 may be manufactured by injection molding, and a transfer shape for transferring the first light guide plate lens 21 may be formed in advance on a molding surface of a forming mold of the first light guide plate 14 for molding the first light guide plate light emission main surface 14B.

As illustrated in FIG. 3, the second light guide plate lens 22 is provided on the first opposite main surface 14C of the first light guide plate 14. The second light guide plate lens 22 extends along the X-axis direction, and a plurality of the second light guide plate lenses 22 are disposed side by side along the Y-axis direction. In the present embodiment, the second light guide plate lens 22 is a convex-shaped prism protruding from the first opposite main surface 14C to the back side. Specifically, the second light guide plate lens 22 has a substantially triangular shape (is substantially mountain-shaped) in a cross section taken along the Y-axis direction, and also extends linearly along the X-axis direction. A width dimension (dimension in the Y-axis direction) of the second light guide plate lens 22 is constant throughout the entire length in the X-axis direction. The second light guide plate lens 22 has a substantially isosceles triangle shape in the cross section, and includes a pair of first light guide plate inclined surfaces 22A. An apex angle of the second light guide plate lens 22 is preferably set to an obtuse angle (angle greater than) 90°, specifically, in a range from 100° to 150°, and is most preferably set to 140°. All the plurality of second light guide plate lenses 22 arranged side by side along the Y-axis direction have substantially the same apex angle, substantially the same width dimension (array interval), and substantially the same height dimension. In the present embodiment, the array interval between the second light guide plate lenses 22 is greater than the array interval between the first light guide plate lenses 21. In order to provide the second light guide plate lens 22 having such a configuration integrally with the first light guide plate 14, for example, the first light guide plate 14 may be manufactured by injection molding, and a transfer shape for transferring the second light guide plate lens 22 may be formed in advance on the molding surface of the forming mold of the first light guide plate 14 for molding the first light guide plate light emission main surface 14B.

According to the first light guide plate 14 having such a configuration, as illustrated in FIG. 3, light propagating inside the first light guide plate 14 is repeatedly reflected by being incident on the first circular arc-shaped surface 21A of each of the first light guide plate lenses 21 on the first light guide plate light emission main surface 14B side in the Z-axis direction, and travels in a zigzag manner substantially along the X-axis direction. On the other hand, the light propagating inside the first light guide plate 14 is repeatedly reflected by being incident on the pair of first light guide plate inclined surfaces 22A of each of the second light guide plate lenses 22 on the first opposite main surface 14C side in the Z-axis direction, and travels in a zigzag manner substantially along the X-axis direction. As a result, the light propagating inside the first light guide plate 14 is restricted from spreading in the Y-axis direction, and thus unevenness of brightness and darkness is less likely to occur between the vicinity of the first LED 13 and surroundings of the first LED 13 in the Y-axis direction.

As illustrated in FIG. 2, the third light guide plate lens 23 is provided on the first opposite main surface 14C of the first light guide plate 14. A plurality of the third light guide plate lenses 23 are disposed side by side at an interval along the X-axis direction. The third light guide plate lens 23 protrudes from the first opposite main surface 14C toward the back side along the Z-axis direction. The third light guide plate lens 23 includes a second light guide plate inclined surface 23A disposed on the side opposite (right side in FIG. 2) to the first LED 13 side in the X-axis direction, a third light guide plate inclined surface 23B disposed on the first LED 13 side (left side in FIG. 2) in the X-axis direction, and a fourth light guide plate inclined surface 23C located between the second light guide plate inclined surface 23A and the third light guide plate inclined surface 23B. The second light guide plate inclined surface 23A has an inclination rising from the first LED 13 side (left side in FIG. 2) of the first light guide plate 14 in the X-axis direction toward the side opposite (right side in FIG. 2) to the first LED 13 side. The third light guide plate inclined surface 23B has an inclination rising from the side opposite (right side in FIG. 2) to the first LED 13 side of the first light guide plate 14 in the X-axis direction toward the first LED 13 side (left side in FIG. 2). The fourth light guide plate inclined surface 23C has an inclination rising from the first LED 13 side (left side in FIG. 2) of the first light guide plate 14 in the X-axis direction toward the side opposite (right side in FIG. 2) to the first LED 13 side.

As illustrated in FIG. 2, the second light guide plate inclined surface 23A and the third light guide plate inclined surface 23B reflect the light propagating inside the first light guide plate 14, raise the light toward the front side so that the light is raised at an angle close to the Z-axis direction, and thus can promote emission of the light from the first light guide plate light emission main surface 14B. Specifically, the second light guide plate inclined surface 23A mainly functions to reflect and raise light traveling away from the first LED 13 in the X-axis direction. On the other hand, the third light guide plate inclined surface 23B mainly functions to reflect and raise light traveling toward the first LED 13 in the X-axis direction. The second light guide plate inclined surface 23A has a gradient in which a distance from the first light guide plate light emission main surface 14B (a portion in which the third light guide plate lens 23 is not installed) becomes smaller with increasing distance from the first LED 13 in the X-axis direction. The second light guide plate inclined surface 23A has an inclination angle of, for example, approximately 8° with respect to the X-axis direction. The third light guide plate inclined surface 23B has a gradient in which a distance from the first light guide plate light emission main surface 14B becomes greater with increasing distance from the first LED 13 in the X-axis direction, that is, a gradient opposite to that of the second light guide plate inclined surface 23A. The third light guide plate inclined surface 23B has a steep, near-perpendicular gradient with an inclination angle of, for example, approximately 80° with respect to the X-axis direction, and the inclination angle is greater than the inclination angle of the second light guide plate inclined surface 23A.

Further, as illustrated in FIGS. 2, 4, and 5, the plurality of third light guide plate lenses 23 arranged side by side along the X-axis direction are designed such that a height dimension (dimension in the Z-axis direction) and a length dimension (dimension in the X-axis direction) each increase with increasing distance from the first LED 13 in the X-axis direction. More specifically, when comparing the third light guide plate lens 23 closer to the first LED 13 in the X-axis direction and the third light guide plate lens 23 farther from the first LED 13 in the X-axis direction, each area of the second light guide plate inclined surface 23A and the third light guide plate inclined surface 23B of the latter is larger than that of the former. In this way, on a side closer to the first LED 13 in the X-axis direction, light is less likely to be incident on the second light guide plate inclined surface 23A and the third light guide plate inclined surface 23B of the third light guide plate lens 23, and light emission is suppressed, but on a side farther from the first LED 13 in the X-axis direction, light is more likely to be incident on the second light guide plate inclined surface 23A and the third light guide plate inclined surface 23B of the third light guide plate lens 23, and light emission is promoted. As a result, an amount of the light emitted from the first light guide plate light emission main surface 14B is made uniform between the first LED 13 side and the side opposite to the first LED 13 side in the X-axis direction.

As illustrated in FIG. 2, in the fourth light guide plate inclined surface 23C, an end portion thereof on the side opposite (right side in FIG. 2) to the first LED 13 side in the X-axis direction is connected to the second light guide plate inclined surface 23A, and an end portion thereof on the first LED 13 side (left side in FIG. 2) in the X-axis direction is connected to the third light guide plate inclined surface 23B. The fourth light guide plate inclined surface 23C has a gradient in which a distance from the first light guide plate light emission main surface 14B (the portion in which the third light guide plate lens 23 is not installed) becomes greater with increasing distance from the first LED 13 in the X-axis direction. In other words, the fourth light guide plate inclined surface 23C has a gradient similar to that of the third light guide plate inclined surface 23B. The fourth light guide plate inclined surface 23C has an inclination angle of, for example, approximately 1.4° with respect to the X-axis direction, and the inclination angle is smaller than both of the inclination angles of the second light guide plate inclined surface 23A and the third light guide plate inclined surface 23B. The fourth light guide plate inclined surface 23C having such a configuration reflects light traveling away from the first LED 13 inside the first light guide plate 14, and thus the light is directed to the first light guide plate light emission main surface 14B side, but an incident angle of the light with respect to the first light guide plate light emission main surface 14B does not exceed a critical angle. Therefore, the light is totally reflected by the first light guide plate light emission main surface 14B, and is guided so as to move away from the first LED 13. In this way, light emitted from the first light guide plate light emission main surface 14B is less likely to be biased toward the first LED 13 side in the X-axis direction. As described above, the first light guide plate 14 is configured such that the inclination angle with respect to the X-axis direction increases in the order of the fourth light guide plate inclined surface 23C, the second light guide plate inclined surface 23A, and the third light guide plate inclined surface 23B. Further, a plurality of the fourth light guide plate inclined surfaces 23C arranged side by side along the X-axis direction are designed such that a length dimension thereof decreases with increasing distance from the first LED 13 in the X-axis direction. This is because a length dimension of the third light guide plate lens 23 increases with increasing distance from the first LED 13 in the X-axis direction, and an occupied range of the third light guide plate lens 23 increases.

As illustrated in FIGS. 3 to 5, the third light guide plate lens 23 having the configuration described above is disposed so as to be sandwiched between two of the second light guide plate lenses 22 that are adjacent to each other in the Y-axis direction. Therefore, the third light guide plate lenses 23 are repeatedly disposed in an alternating manner with the second light guide plate lenses 22 in the Y-axis direction. In the third light guide plate lens 23, a maximum value of a protrusion dimension (height dimension) from the first opposite main surface 14C is set smaller than a protrusion dimension of the second light guide plate lens 22 from the first opposite main surface 14C. Therefore, even the third light guide plate lens 23 located on the farthest side from the first LED 13 in the X-axis direction does not protrude farther toward the back side than the second light guide plate lens 22.

Herein, the liquid crystal display device 10 for vehicle application may be located and installed in front of a front passenger seat of a passenger vehicle, for example. In that case, for example, while the passenger vehicle is traveling, it may be required to restrict a viewing angle such that, while a display image of the liquid crystal display device 10 can be visually recognized from the front passenger seat, the display image of the liquid crystal display device 10 cannot be visually recognized from the driver's seat. Furthermore, for example, while the passenger vehicle is stopped, it may be required to not restrict the viewing angle such that a display image of the liquid crystal display device 10 can be visually recognized from both the front passenger seat and the driver's seat. Note that the liquid crystal display device 10 for vehicle application is installed in a posture in which the X-axis direction substantially coincides with the horizontal direction and the Y-axis direction is parallel to the perpendicular direction. As illustrated in FIG. 1, in order to respond to such a request, the backlight device 12 according to the present embodiment includes at least a first louver (first sheet) 18 disposed on the front side of the second prism sheet 17, a second LED (second light source) 24, and a second light guide plate 25 disposed on the top surface of the first louver 18, in addition to each of the configurations described above. Further, the backlight device 12 according to the present embodiment includes a second louver 30 disposed on the front side of the second light guide plate 25 in order to prevent reflection on a windshield of the passenger vehicle. The second louver 30 will be described later.

A configuration of the first louver 18 will be described by using FIGS. 1 and 2. As illustrated in FIG. 1, the first louver 18 includes a main surface having a sheet shape parallel to each of the main surfaces of the liquid crystal panel 11, the first light guide plate 14, and the like. Note that the main surface of the first louver 18 is parallel to the X-axis direction and the Y-axis direction, and a normal direction (thickness direction) of the main surface coincides with the Z-axis direction. The first louver 18 has a function of restricting an emission angle range of light in the X-axis direction. The first louver 18 includes a first light incident main surface (third main surface) 18A on the back side, and a first light emission main surface (fourth main surface) 18B on the front side. The first light incident main surface 18A faces the main surface of the second prism sheet 17 on the front side (light emission side). The first light emission main surface 18B faces a second opposite main surface 25C, of the second light guide plate 25, which will be described below.

As illustrated in FIG. 2, the first louver 18 includes a first light blocking portion 18C that blocks light, and a first light-transmitting portion 18D that transmits light. The first light blocking portion 18C is formed of, for example, a light blocking resin material (light blocking material) that exhibits a black color and blocks light. The first light blocking portion 18C has a layer shape extending along the Y-axis direction and the Z-axis direction, and a plurality of the first light blocking portions 18C are disposed side by side at an interval in the X-axis direction. The first light-transmitting portion 18D is formed of a light-transmissive resin material (light-transmissive material) that is substantially transparent and transmits light. The first light-transmitting portion 18D has a layer shape extending along the Y-axis direction and the Z-axis direction, and a plurality of the first light-transmitting portions 18D are disposed side by side at an interval in the X-axis direction. The plurality of first light blocking portions 18C and the plurality of first light-transmitting portions 18D are repeatedly disposed side by side in an alternate manner in the X-axis direction. Therefore, the first light-transmitting portion 18D is interposed between two of the first light blocking portions 18C that are adjacent to each other at an interval in the X-axis direction, and the first light blocking portion 18C is interposed between two of the first light-transmitting portions 18D that are adjacent to each other at an interval in the X-axis direction. Light incident on the first light incident main surface 18A of the first louver 18 transmits through the first light-transmitting portion 18D disposed between the two first light blocking portions 18C that are adjacent to each other in the X-axis direction, and is emitted from the first light emission main surface 18B. An emission angle of light emitted from the first light emission main surface 18B in the X-axis direction is restricted by the two first light blocking portions 18C that are adjacent to each other in the X-axis direction. Note that the light emitted from the first light emission main surface 18B has an emission angle that is not restricted by the first louver 18 in the Y-axis direction. An emission angle range of the light emitted from the first light emission main surface 18B in the X-axis direction is defined by two straight lines that diagonally connect each end portion in the Z-axis direction of the two first light blocking portions 18C that sandwich the first light-transmitting portion 18D therebetween. An emission angle range of light transmitted through the first light-transmitting portion 18D in the X-axis direction changes in accordance with a ratio between a width W1 and a height H1 of the first light-transmitting portion 18D. Further, the first louver 18 includes a pair of sheet carriers that sandwich the plurality of first light blocking portions 18C and the plurality of first light-transmitting portions 18D from the front side and the back side and carry them. The sheet carrier is formed of a light-transmissive resin material that is substantially transparent and transmits light. The sheet carrier extends over the entire region of the first louver 18, and collectively holds the plurality of first light blocking portions 18C and the plurality of first light-transmitting portions 18D.

Specifically, as illustrated in FIG. 2, in the first louver 18, a ratio obtained by dividing the width W1 by the height H1 of the first light-transmitting portion 18D is equal to “tan 10°”. In this way, a maximum absolute value of an angle formed by the light transmitted through the first light-transmitting portion 18D with respect to the Z-axis direction is 10°. As compared to when a ratio obtained by dividing the width by the height of the first light-transmitting portion 18D is greater than “tan 10°”, an emission angle range of light emitted by the backlight device 12 is sufficiently narrowed. In this way, this embodiment is suitable for restricting a viewing angle such that, while a display image of the liquid crystal display device 10 can be visually recognized from the front passenger seat, the display image of the liquid crystal display device 10 cannot be visually recognized from the driver's seat. Further, as compared to when the ratio obtained by dividing the width by the height of the first light-transmitting portion 18D is smaller than “tan 10°”, an amount of the light blocked by the first light blocking portion 18C decreases, and the light usage efficiency is improved.

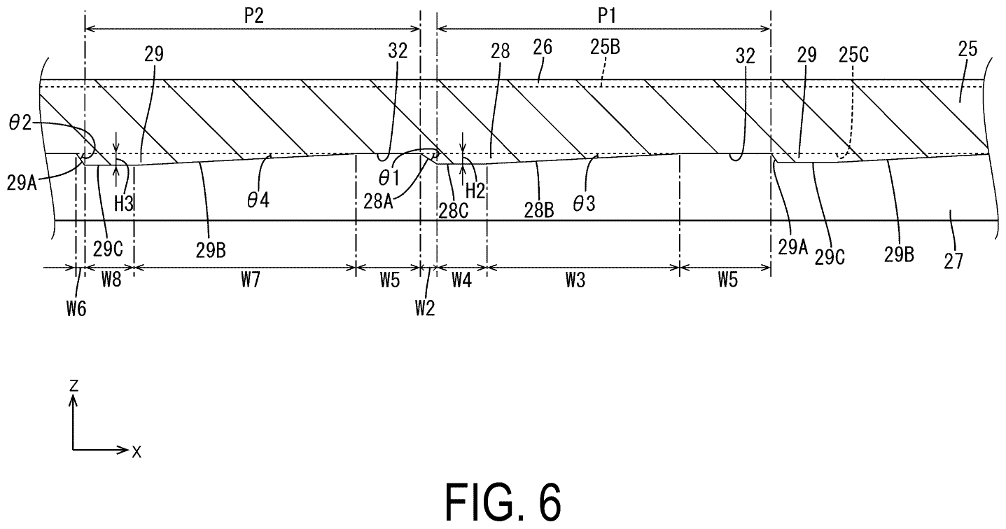

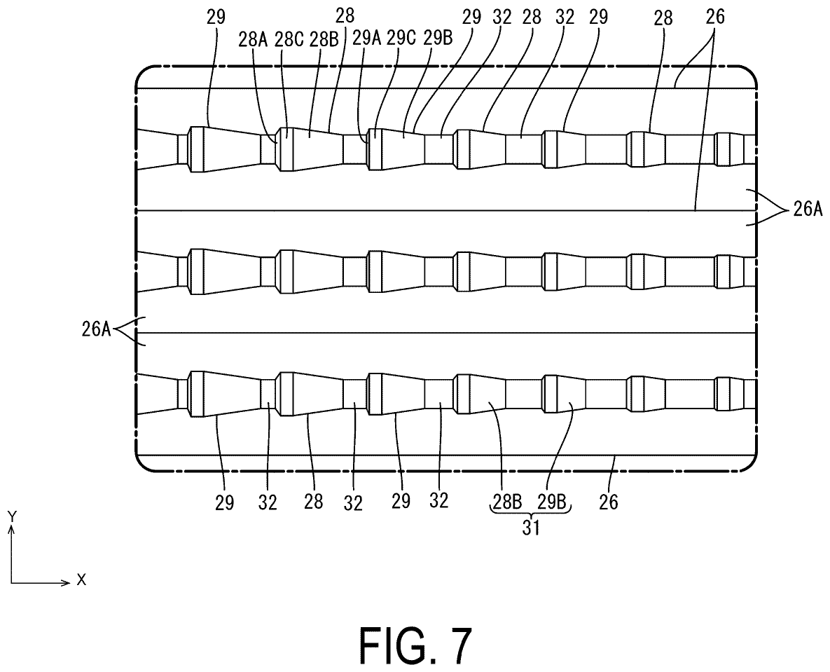

A configuration of the second LED 24 and the second light guide plate 25 will be described by appropriately using FIGS. 1 to 3, 6, and 7. FIG. 6 is an enlarged cross-sectional view of the second light guide plate 25 among components of the backlight device 12. FIG. 7 is a bottom view illustrating a main surface of the second light guide plate 25 on the back side. As illustrated in FIG. 1, the second LED 24 has a substantially block shape, and one surface of a pair of surfaces thereof along the Y-axis direction and the Z-axis direction is a second light-emitting surface 24A that emits light. A plurality of the second LEDs 24 are disposed side by side at an interval along the Y-axis direction. The second LED 24 is mounted on an LED substrate. The second LED 24 has a configuration in which an LED chip is sealed with a sealing material on a substrate portion mounted on the LED substrate. The LED chip provided in the second LED 24 emits light of a single color, for example, blue light. A phosphor is dispersed and mixed in the sealing material provided in the second LED 24. The phosphor contained in the sealing material includes a yellow phosphor, a green phosphor, a red phosphor, and the like. The second LED 24 including such an LED chip and such a sealing material emits white light as a whole.

The second light guide plate 25 is formed of a synthetic resin material (for example, an acrylic resin such as PMMA or the like) that has a sufficiently higher refractive index than that of the air and that is substantially transparent. As illustrated in FIG. 1, the second light guide plate 25 has a plate shape, and a main surface of the second light guide plate 25 is parallel to the main surface of the liquid crystal panel 11 and the like. Note that the main surface of the second light guide plate 25 is parallel to the X-axis direction and the Y-axis direction, and a normal direction (thickness direction) of the main surface coincides with the Z-axis direction. The second light guide plates 25 are arranged side by side along the X-axis direction (first direction) with respect to the second LED 24, and are also disposed side by side along the Z-axis direction with respect to the liquid crystal panel 11, the first louver 18, and the like. The second light guide plate 25 is disposed on the other side (left side in FIG. 1) of the second LED 24 in the X-axis direction. In other words, a positional relationship between the second light guide plate 25 and the second LED 24 in the X-axis direction is reverse to a positional relationship between the first light guide plate 14 and the first LED 13 in the X-axis direction. In this way, the first LED 13 and the second LED 24 are disposed in a distributed manner in the X-axis direction, and thus, even when both of the first LED 13 and the second LED 24 are turned on, heat is less likely to persist.

As illustrated in FIG. 1, one end surface of an outer peripheral end surface of the second light guide plate 25 is a second light incident end surface (second end surface) 25A facing the second light-emitting surface 24A of the second LED 24. The second light incident end surface 25A is a surface parallel to the second light-emitting surface 24A of the second LED 24, and light emitted from the second light-emitting surface 24A is incident on the second light incident end surface 25A. Therefore, it can be said that the second LED 24 is disposed only on one side of the second light guide plate 25 in the X-axis direction, and the second light guide plate 25, together with the second LED 24, constitutes a backlight unit of a one-side light incident type. Of a pair of main surfaces of the second light guide plate 25, the main surface on the front side facing the second louver 30 described below is a second light guide plate light emission main surface (fifth main surface) 25B that emits light that has been guided inside the second light guide plate 25. Of the pair of main surfaces of the second light guide plate 25, the main surface on the back side facing the first louver 18 is the second opposite main surface (sixth main surface) 25C located on the side opposite to the second light guide plate light emission main surface 25B. The second opposite main surface 25C of the second light guide plate 25 is disposed so as to face the first light emission main surface 18B of the first louver 18 in the Z-axis direction. Then, the second light guide plate 25 can introduce, from the second light incident end surface 25A, light emitted from the second LED 24 toward the second light guide plate 25, can propagate the light therein, then, can cause the light to rise along the Z-axis direction such that the light is directed toward the liquid crystal panel 11 on the front side (light emission side), and can emit the light from the second light guide plate light emission main surface 25B. In addition, the second light guide plate 25 can introduce, from the second opposite main surface 25C, light emitted from the first louver 18, and also can emit the light from the second light guide plate light emission main surface 25B toward the second louver 30 on the front side (liquid crystal panel 11). Note that a normal direction of the second light incident end surface 25A coincides with the X-axis direction (an arrangement direction of the second LED 24 and the second light guide plate 25).

As illustrated in FIGS. 2 and 3, a fourth light guide plate lens 26, a fifth light guide plate lens 27, and a sixth light guide plate lens (first lens) 28, and a seventh light guide plate lens (second lens) 29 are provided on the second light guide plate 25. As illustrated in FIG. 3, the fourth light guide plate lens 26 is provided on the second light guide plate light emission main surface 25B of the second light guide plate 25. The fourth light guide plate lens 26 extends along the X-axis direction, and a plurality of the fourth light guide plate lenses 26 are disposed side by side along the Y-axis direction. In the present embodiment, the fourth light guide plate lens 26 is a so-called lenticular lens. The fourth light guide plate lens 26 has a convex shape protruding from the second light guide plate light emission main surface 25B to the front side. Specifically, the fourth light guide plate lens 26 has a semi-circular shape in a cross section taken along the Y-axis direction and a semi-cylindrical shape linearly extending along the X-axis direction, and a surface of the fourth light guide plate lens 26 is a second circular arc-shaped surface 26A. When an angle formed by a tangent line at a base end portion of the second circular arc-shaped surface 26A with respect to the Y-axis direction is defined as a “contact angle”, a contact angle of the fourth light guide plate lens 26 is, for example, approximately 30°. All the plurality of fourth light guide plate lenses 26 arranged side by side along the Y-axis direction have substantially the same contact angle, substantially the same width dimension (array interval), and substantially the same height dimension. In order to provide the fourth light guide plate lens 26 having such a configuration integrally with the second light guide plate 25, for example, the second light guide plate 25 may be manufactured by injection molding, and a transfer shape for transferring the fourth light guide plate lens 26 may be formed in advance on a molding surface of a forming mold of the second light guide plate 25 for molding the second light guide plate light emission main surface 25B.

As illustrated in FIG. 3, the fifth light guide plate lens 27 is provided on the second opposite main surface 25C of the second light guide plate 25. The fifth light guide plate lens 27 extends along the X-axis direction, and a plurality of the fifth light guide plate lenses 27 are disposed side by side along the Y-axis direction. In the present embodiment, the fifth light guide plate lens 27 is a convex-shaped prism protruding from the second opposite main surface 25C to the back side. Specifically, the fifth light guide plate lens 27 has a substantially triangular shape (is substantially mountain-shaped) in a cross section taken along the Y-axis direction, and also extends linearly along the X-axis direction. A width dimension (dimension in the Y-axis direction) of the fifth light guide plate lens 27 is set to be constant throughout the entire length in the X-axis direction. The fifth light guide plate lens 27 has an approximately isosceles triangle shape in the cross section, and includes a pair of fifth light guide plate inclined surfaces 27A. An apex angle of the fifth light guide plate lens 27 is preferably set to an obtuse angle (angle greater than) 90°, specifically, in a range from 100° to 150°, and is most preferably set to 140°. A width dimension, that is, a dimension in the Y-axis direction of the fifth light guide plate lens 27 is, for example, approximately 0.126 mm. An array interval of the plurality of fifth light guide plate lenses 27 arranged side by side along the Y-axis direction (an interval between the apexes of two of the fifth light guide plate lenses 27 arranged side by side along the Y-axis direction) is, for example, approximately 0.175 mm. All the plurality of fifth light guide plate lenses 27 arranged side by side along the Y-axis direction have substantially the same apex angle, substantially the same width dimension (array interval), and substantially the same height dimension. In the present embodiment, the array interval of the fifth light guide plate lenses 27 is greater than the array interval of the fourth light guide plate lenses 26. In order to provide the fifth light guide plate lens 27 having such a configuration integrally with the second light guide plate 25, for example, the second light guide plate 25 may be manufactured by injection molding, and a transfer shape for transferring the fifth light guide plate lens 27 may be formed in advance on a molding surface of a forming mold of the second light guide plate 25 for molding the second opposite main surface 25C.

As illustrated in FIG. 2, the sixth light guide plate lens 28 and the seventh light guide plate lens 29 are provided on the second opposite main surface 25C of the second light guide plate 25. The sixth light guide plate lens 28 and the seventh light guide plate lens 29 protrude from the second opposite main surface 25C toward the back side along the Z-axis direction. A plurality of the sixth light guide plate lenses 28 and a plurality of the seventh light guide plate lenses 29 are repeatedly disposed side by side in an alternate manner at an interval along the X-axis direction. The sixth light guide plate lens 28 has a first inclined surface 28A disposed on the side (left side in FIG. 2) opposite to the second LED 24 side in the X-axis direction. The seventh light guide plate lens 29 has a second inclined surface 29A disposed on the side opposite to the second LED 24 side in the X-axis direction. Each of the first inclined surface 28A and the second inclined surface 29A has an inclination rising from the second LED 24 side (right side in FIG. 2) of the second light guide plate 25 in the X-axis direction toward the side (left side in FIG. 2) opposite to the second LED 24 side. The first inclined surface 28A has a gradient such that the thickness of the sixth light guide plate lens 28 is continuously and gradually reduced from the second LED 24 side toward the side opposite to the second LED 24 side in the X-axis direction. Similarly, the second inclined surface 29A has a gradient such that the thickness of the seventh light guide plate lens 29 is continuously and gradually reduced from the second LED 24 side toward the side opposite to the second LED 24 side in the X-axis direction.

As illustrated in FIG. 2, each of the sixth light guide plate lens 28 and the seventh light guide plate lens 29 has a third inclined surface 31 disposed on the second LED 24 side in the X-axis direction. The third inclined surface 31 has an inclination rising from the side opposite to the second LED 24 side of the second light guide plate 25 toward the second LED 24 side in the X-axis direction. The third inclined surface 31 includes a fourth inclined surface 28B provided in the sixth light guide plate lens 28, and a fifth inclined surface 29B provided in the seventh light guide plate lens 29. The fourth inclined surface 28B is disposed, in the sixth light guide plate lens 28, at a position spaced apart from the first inclined surface 28A in the X-axis direction, the first inclined surface 28A being located further to the second LED 24 side than the fourth inclined surface 28B. The fourth inclined surface 28B provided in the sixth light guide plate lens 28 is disposed so as to face the second inclined surface 29A provided in the seventh light guide plate lens 29 with an interval therebetween. The fourth inclined surface 28B has a gradient such that the thickness of the sixth light guide plate lens 28 continuously and gradually increases from the second LED 24 side toward the side opposite to the second LED 24 side in the X-axis direction. The fifth inclined surface 29B is disposed, in the seventh light guide plate lens 29, at a position spaced apart from the second inclined surface 29A in the X-axis direction, the second inclined surface 29A being located further to the second LED 24 side than the fifth inclined surface 29B. The fifth inclined surface 29B provided in the seventh light guide plate lens 29 is disposed so as to face the first inclined surface 28A provided in the sixth light guide plate lens 28 with an interval therebetween. The fifth inclined surface 29B has a gradient such that the thickness of the seventh light guide plate lens 29 continuously and gradually increases from the second LED 24 side toward the side opposite to the second LED 24 side in the X-axis direction.

As illustrated in FIG. 2, the sixth light guide plate lens 28 has a first plane 28C located between the first inclined surface 28A and the fourth inclined surface 28B. The seventh light guide plate lens 29 has a second plane 29C located between the second inclined surface 29A and the fifth inclined surface 29B. Each of the first plane 28C and the second plane 29C is a surface parallel to the X-axis direction and the Y-axis direction. Further, on the second opposite main surface 25C of the second light guide plate 25, a third plane 32 is provided between the sixth light guide plate lens 28 and the seventh light guide plate lens 29 that are adjacent to each other at an interval in the X-axis direction. The third plane 32 is a surface parallel to the X-axis direction and the Y-axis direction. A plurality of the third planes 32 are disposed at an interval in the X-axis direction on the second opposite main surface 25C of the second light guide plate 25. The sixth light guide plate lens 28 or the seventh light guide plate lens 29 is interposed between two of the third planes 32 adjacent to each other at an interval in the X-axis direction. Detailed configurations, actions, and effects of the inclined surfaces 28A, 29A, and 31 (28B, 29B) and the planes 28C, 29C, and 32 will be described later in detail.

Next, a configuration of the second louver 30 will be described with reference to FIGS. 1 and 3. As illustrated in FIG. 1, the second louver 30 includes a main surface having a sheet shape parallel to each of the main surfaces of the liquid crystal panel 11, the second light guide plate 25, and the like. Note that the main surface of the second louver 30 is parallel to the X-axis direction and the Y-axis direction, and a normal direction (thickness direction) of the main surface coincides with the Z-axis direction. The second louver 30 has a function of restricting an emission angle range of light in the Y-axis direction. The second louver 30 includes a second light incident main surface 30A on the back side, and a second light emission main surface 30B on the front side. The second light incident main surface 30A faces the second light guide plate light emission main surface 25B of the second light guide plate 25. The second light emission main surface 30B faces the main surface of the liquid crystal panel 11 on the back side. In other words, the second louver 30 is disposed so as to be located on the front side of the second light guide plate 25 and on the back side of the liquid crystal panel 11.

As illustrated in FIG. 3, the second louver 30 includes a second light blocking portion 30C that blocks light, and a second light-transmitting portion 30D that transmits light. The second light blocking portion 30C is formed of, for example, a light blocking resin material (light blocking material) that exhibits a black color and blocks light. The second light blocking portion 30C has a layer shape extending along the X-axis direction and the Z-axis direction, and a plurality of the second light blocking portions 30C are disposed side by side at an interval in the Y-axis direction. The second light-transmitting portion 30D is formed of a light-transmissive resin material (light-transmissive material) that is substantially transparent and transmits light. The second light-transmitting portion 30D has a layer shape extending along the X-axis direction and the Z-axis direction, and a plurality of the second light-transmitting portions 30D are disposed side by side at an interval in the Y-axis direction. The plurality of second light blocking portions 30C and the plurality of second light-transmitting portions 30D are repeatedly disposed side by side in an alternate manner in the Y-axis direction. Therefore, the second light-transmitting portion 30D is interposed between two of the second light blocking portions 30C that are adjacent to each other at an interval in the Y-axis direction, and the second light blocking portion 30C is interposed between two of the second light-transmitting portions 30D that are adjacent to each other with an interval therebetween in the Y-axis direction. Light incident on the second light incident main surface 30A of the second louver 30 transmits through the second light-transmitting portion 30D disposed between the two of the second light blocking portions 30C that are adjacent to each other in the Y-axis direction, and is emitted from the second light emission main surface 30B. An emission angle of the light emitted from the second light emission main surface 30B in the Y-axis direction is restricted by the two second light blocking portions 30C that are adjacent to each other in the Y-axis direction. Note that the light emitted from the second light emission main surface 30B has an emission angle that is not restricted by the second louver 30 in the X-axis direction. An emission angle range of the light emitted from the second light emission main surface 30B in the Y-axis direction is defined by two straight lines that diagonally connect each end portion in the Z-axis direction of the two second light blocking portions 30C that sandwich the second light-transmitting portion 30D therebetween. An emission angle range of the light transmitted through the second light-transmitting portion 30D in the Y-axis direction changes in accordance with a ratio between the width and the height of the second light-transmitting portion 30D. In the second louver 30, a ratio obtained by dividing the width by the height of the second light-transmitting portion 30D is greater than the ratio obtained by dividing the width W1 by the height H1 of the first light-transmitting portion 18D in the first louver 18. Specifically, in the second louver 30, a ratio obtained by dividing a width W by the height of the second light-transmitting portion 30D is, for example, “tan 55°” or greater. Further, the second louver 30 includes a pair of sheet carriers that sandwich the plurality of second light blocking portions 30C and the plurality of second light-transmitting portions 30D from the front side and the back side and carry them. The sheet carrier is formed of a light-transmissive resin material that is substantially transparent and transmits light. The sheet carrier extends over the entire region of the second louver 30, and collectively holds the plurality of second light blocking portions 30C and the plurality of second light-transmitting portions 30D.

When the liquid crystal display device 10 is mounted on the passenger vehicle, an emission angle range of light emitted from the liquid crystal panel 11 can be restricted to the perpendicular direction by using the second louver 30 described above. As a result, reflection of a display image on the windshield can be made less likely to occur.

Next, the first inclined surface 28A and the second inclined surface 29A provided in the sixth light guide plate lens 28 and the seventh light guide plate lens 29, respectively, will be described in detail. First, as illustrated in FIG. 6, an angle formed by the first inclined surface 28A provided in the sixth light guide plate lens 28 with respect to the X-axis direction is referred to as a “first angle θ1”, and an angle formed by the second inclined surface 29A provided in the seventh light guide plate lens 29 with respect to the X-axis direction is referred to as a “second angle θ2”. The first angle θ1 of the first inclined surface 28A is greater than 27° and smaller than the second angle θ2. The second angle θ2 of the second inclined surface 29A is greater than the first angle θ1 and smaller than 58°. In the present embodiment, specifically, the first angle θ1 of the first inclined surface 28A is, for example, approximately 32°. The second angle θ2 of the second inclined surface 29A is, for example, approximately 54°.

According to such a configuration, as illustrated in FIG. 6, light emitted from the second LED 24 and incident on the second light incident end surface 25A of the second light guide plate 25 is incident on the first inclined surface 28A and the second inclined surface 29A in a process of propagating inside the second light guide plate 25, and most of the light is reflected there. The light reflected by the first inclined surface 28A and the second inclined surface 29A is raised toward the front side, and promoted to be emitted from the second light guide plate light emission main surface 25B. Here, the traveling direction of the light reflected by the first inclined surface 28A and the second inclined surface 29A becomes a direction corresponding to the angles of the first inclined surface 28A and the second inclined surface 29A with respect to the X-axis direction. Specifically, for example, when the angle formed by one of the first inclined surface 28A and the second inclined surface 29A with respect to the X-axis direction is 45°, the reflected light is raised so as to travel along the Z-axis direction (the normal direction of the second light guide plate light emission main surface 25B, a front direction). For example, when the angle formed by one of the first inclined surface 28A and the second inclined surface 29A with respect to the X-axis direction is less than 45°, the reflected light tends to travel toward the side (left side in FIG. 6) opposite to the second LED 24 side in the X-axis direction with respect to the Z-axis direction. For example, when the angle formed by one of the first inclined surface 28A and the second inclined surface 29A with respect to the X-axis direction exceeds 45°, the reflected light tends to travel toward the second LED 24 side (right side in FIG. 6) in the X-axis direction with respect to the Z-axis direction.

In the present embodiment, since the first angle θ1 is approximately 32° and is less than 45°, when the light reflected by the first inclined surface 28A is emitted from the second light guide plate light emission main surface 25B, the light is likely to travel toward the side (the side away from the second LED 24 side) opposite to the second LED 24 side in the X-axis direction with respect to the Z-axis direction. On the other hand, since the second angle θ2 is approximately 54° and exceeds 45°, when the light reflected by the second inclined surface 29A is emitted from the second light guide plate light emission main surface 25B, the light is likely to travel toward the second LED 24 side (the side closer to the second LED 24) in the X-axis direction with respect to the Z-axis direction. Therefore, when the second LED 24 is turned on, emission light can be supplied that has a brightness angle distribution in which peak brightnesses of the emission light are biased toward both the side opposite to the second LED 24 side in the X-axis direction and the second LED 24 side in the X-axis direction. As a result, brightness of the emission light in a direction inclined with respect to the Z-axis direction can be sufficiently secured, and in addition, an emission angle range of the emission light is expanded, which is preferable in terms of achieving widening of the viewing angle.

Then, as both the first angle θ1 and the second angle θ2 become closer to 45°, the light reflected by the first inclined surface 28A and the second inclined surface 29A tends to travel in a direction closer to the Z-axis direction. Specifically, in the present embodiment, since the first angle θ1 of the first inclined surface 28A is greater than 27° and close to 45°, when the light reflected by the first inclined surface 28A is emitted from the second light guide plate light emission main surface 25B, the light travels in a direction closer to the Z-axis direction as compared to when the first angle θ1 is set to 27° or less. On the other hand, since the second angle θ2 of the second inclined surface 29A is less than 58° and close to 45°, when the light reflected by the second inclined surface 29A is emitted from the second light guide plate light emission main surface 25B, the light travels in a direction closer to the Z-axis direction as compared to when the second angle θ2 is set to 58° or greater. Therefore, when both the first LED 13 and the second LED 24 are turned on, in the brightness angle distribution of the light emitted from the second light guide plate light emission main surface 25B, the brightness tends to become lower toward wide-angle sides with respect to the Z-axis direction, and the brightness is less likely to decrease locally in the middle of the range. As described above, it is possible to make it less likely for the unevenness of brightness to occur while achieving the widening of the viewing angle.

According to the present embodiment, as illustrated in FIG. 1, for example, while the passenger vehicle travels, the first LED 13 is turned on and the second LED 24 is turned off. Then, since the light emitted from the second light guide plate light emission main surface 25B of the second light guide plate 25 has the angle range restricted by the first light blocking portion 18C of the first louver 18, the light becomes less likely to be emitted outside the restricted angle range. Therefore, when the first LED 13 is turned on and the second LED 24 is turned off, light is selectively emitted from the backlight device 12 in the restricted angle range. Thus, while a display image of the liquid crystal display device 10 can be visually recognized from the front passenger seat, the display image of the liquid crystal display device 10 cannot be visually recognized from the driver's seat. In contrast, for example, while the passenger vehicle is stopped, both of the first LED 13 and the second LED 24 are turned on. Then, the light emitted from the second light guide plate light emission main surface 25B of the second light guide plate 25 includes light of the first LED 13 having the angle range restricted by the first louver 18, and light of the second LED 24 having the brightness angle distribution in which the peak brightnesses of the light are biased toward both the side opposite to the second LED 24 side and the second LED 24 side in the X-axis direction. Therefore, when both of the first LED 13 and the second LED 24 are turned on, from the backlight device 12, in addition to the light in the restricted angle range, the light having the brightness angle distribution in which the peak brightnesses are biased toward both the side opposite to the second LED 24 side and the second LED 24 side in the X-axis direction is emitted. Thus, a display image of the liquid crystal display device 10 can be visually recognized from both the driver's seat and the front passenger seat, and further, the display image can be visually recognized with a wide viewing angle particularly from the front passenger seat. In this way, whether or not the display image can be visually recognized from the driver's seat can be adjusted by controlling driving of the second LED 24 in accordance with a traveling situation of the passenger vehicle.

Next, the third inclined surface 31 provided in each of the sixth light guide plate lens 28 and the seventh light guide plate lens 29 will be described in detail. First, as illustrated in FIG. 6, of the third inclined surface 31, an angle formed by the fourth inclined surface 28B provided in the sixth light guide plate lens 28 with respect to the X-axis direction is referred to as a “third angle θ3”, and an angle formed by the fifth inclined surface 29B provided in the seventh light guide plate lens 29 with respect to the X-axis direction is referred to as a “fourth angle θ4”. The third angle θ3 of the fourth inclined surface 28B is, for example, in a range from 3° to 10°, and more specifically, approximately 3°. The fourth angle θ4 of the fifth inclined surface 29B is, for example, in a range from 3° to 10°, and more specifically, approximately 3°. In the present embodiment, the third angle θ3 of the fourth inclined surface 28B is equal to the fourth angle θ4 of the fifth inclined surface 29B. According to such a configuration, when light traveling toward the second LED 24 in the X-axis direction inside the second light guide plate 25 is incident on the fourth inclined surface 28B and the fifth inclined surface 29B, which are the third inclined surfaces 31, and refracted, the light travels to the side opposite to the second LED 24 side in the X-axis direction with respect to the Z-axis direction. As a result, brightness of emission light in a direction inclined with respect to the Z-axis direction can be further improved. Further, when light traveling away from the second LED 24 in the X-axis direction inside the second light guide plate 25 is incident on the fourth inclined surface 28B and the fifth inclined surface 29B, which are the third inclined surface 31, and refracted, the light is guided so as to travel farther away from the second LED 24. As a result, emission light from the second light guide plate light emission main surface 25B is less likely to be biased toward the second LED 24 side in the X-axis direction.

Next, the first plane 28C, the second plane 29C, and the third plane 32 will be described in detail. The first plane 28C, the second plane 29C and the third plane 32 are parallel to the X-axis direction and the Y-axis direction, and a normal direction of each of the first plane 28C the second plane 29C, and the third plane 32 coincides with the Z-axis direction, as illustrated in FIG. 6. Light emitted from the first light guide plate light emission main surface 14B of the first light guide plate 14 and incident on the second opposite main surface 25C of the second light guide plate 25 travels hardly refracted even when the light is incident on one of the first plane 28C, the second plane 29C, and the third plane 32. Therefore, as compared to a configuration in which the first inclined surface 28A and the fourth inclined surface 28B are directly connected to each other without having the first plane 28C interposed therebetween, a configuration in which the second inclined surface 29A and the fifth inclined surface 29B are directly connected to each other without having the second plane 29C interposed therebetween, and a configuration in which the sixth light guide plate lens 28 and the seventh light guide plate lens 29, which are adjacent to each other in the X-axis direction, are directly connected to each other without having the third plane 32 interposed therebetween, an occurrence of side lobe light traveling in a direction inclined to the side opposite to the second LED 24 side in the X-axis direction with respect to the Z-axis direction can be suppressed.

As illustrated in FIGS. 6 and 7, the plurality of sixth light guide plate lenses 28 and the plurality of seventh light guide plate lenses 29, which are arranged side by side along the X-axis direction, are designed such that height dimensions (dimensions in the Z-axis direction) H2 and H3 increase with increasing distance from the second LED 24 in the X-axis direction, but array pitches (array intervals) P1 and P2 in the X-axis direction are constant. Respective width dimensions (dimensions in the X-axis direction) W2 and W6 of the first inclined surface 28A and the second inclined surface 29A both increase with increasing distance from the second LED 24 in the X-axis direction. Respective width dimensions (dimensions in the X-axis direction) W3 and W7 of the fourth inclined surface 28B and the fifth inclined surface 29B increase with increasing distance from the second LED 24 in the X-axis direction, and increase rates of the width dimensions W3 and W7 are higher than those of the first inclined surface 28A the second inclined surface 29A. Respective width dimensions (dimensions in the X-axis direction) W4 and W8 of the first plane 28C and the second plane 29C are set to be constant regardless of the position in the X-axis direction. A width dimension (dimension in the X-axis direction) W5 of the third plane 32 decreases with increasing distance from the second LED 24 in the X-axis direction. The array pitch P1 of the sixth light guide plate lenses 28 in the X-axis direction is a sum of the width dimension W2 of the first inclined surface 28A, the width dimension W3 of the fourth inclined surface 28B, the width dimension W4 of the first plane 28C, and the width dimension W5 of the third plane 32. The array pitch P2 of the seventh light guide plate lenses 29 in the X-axis direction is a sum of the width dimension W6 of the second inclined surface 29A, the width dimension W7 of the fifth inclined surface 29B, the width dimension W8 of the second plane 29C, and the width dimension W5 of the third plane 32.

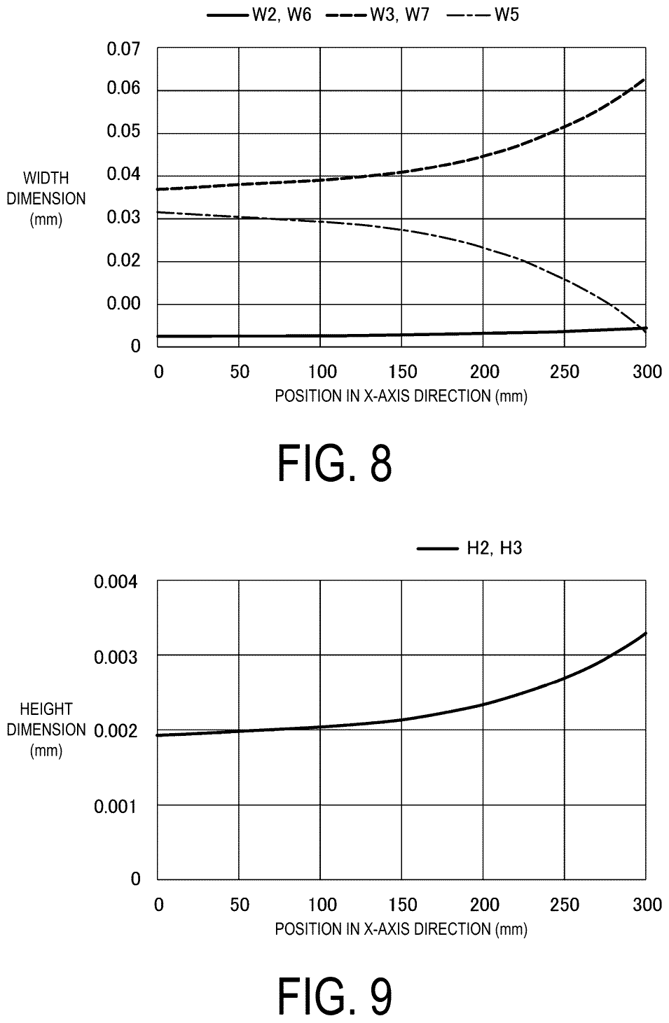

As illustrated in FIG. 8, specific numerical values of the width dimension W2 of the first inclined surface 28A, the width dimension W6 of the second inclined surface 29A, the width dimension W3 of the fourth inclined surface 28B, the width dimension W7 of the fifth inclined surface 29B, and the width dimension W5 of the third plane 32 change in accordance with the positions of the sixth light guide plate lens 28 and the seventh light guide plate lens 29 in the second light guide plate 25 in the X-axis direction. FIG. 8 is a graph in which the horizontal axis indicates the position (in units of “mm”) of the second light guide plate 25 in the X-axis direction, and the vertical axis indicates the respective width dimensions W2, W3, W5, W6, and W7 (in units of “mm”) of the first inclined surface 28A, the second inclined surface 29A, the fourth inclined surface 28B, the fifth inclined surface 29B, and the third plane 32. A reference position (0 mm) in the horizontal axis in FIG. 8 is the position of the second light incident end surface 25A of the second light guide plate 25, and the position of 300 mm is the position of an end surface on the side opposite to the second light incident end surface 25A of the second light guide plate 25. A solid line illustrated in FIG. 8 is a graph showing the respective width dimensions W2 and W6 of the first inclined surface 28A and the second inclined surface 29A, a broken line is a graph showing the respective width dimensions W3 and W7 of the fourth inclined surface 28B and the fifth inclined surface 29B, and a dot-dash line is a graph showing the width dimension W5 of the third plane 32. As illustrated in FIG. 9, when the length dimension of the second light guide plate 25 is set to, for example, 300 mm, specific numerical values of the respective height dimensions H2 and H3 of the sixth light guide plate lens 28 and the seventh light guide plate lens 29 change in accordance with the positions of the sixth light guide plate lens 28 and the seventh light guide plate lens 29 in the second light guide plate 25 in the X-axis direction. FIG. 9 is a graph in which the horizontal axis indicates the position (in units of “mm”) of the second light guide plate 25 in the X-axis direction, and the vertical axis indicates the respective height dimensions H2 and H3 (in units of “mm”) of the sixth light guide plate lens 28 and the seventh light guide plate lens 29.

Specifically, when the length dimension (dimension in the X-axis direction) of the second light guide plate 25 is set to, for example, 300 mm, the respective array pitches P1 and P2 of the sixth light guide plate lenses 28 and the seventh light guide plate lenses 29 in the X-axis direction are both constant at approximately 0.114 mm, for example. The respective width dimensions W4 and W8 of the first plane 28C and the second plane 29C are both constant at approximately 0.017 mm, for example. According to FIG. 8, the respective width dimensions W2 and W6 of the first inclined surface 28A and the second inclined surface 29A vary in a range from 0.003 mm to 0.004 mm, for example. According to FIG. 8, the respective width dimensions W3 and W7 of the fourth inclined surface 28B and the fifth inclined surface 29B vary in a range from 0.037 mm to 0.063 mm, for example. According to FIG. 8, the width dimension W5 of the third plane 32 varies in a range from 0.003 mm to 0.032 mm, for example. According to FIG. 9, the respective height dimensions H2 and H3 of the sixth light guide plate lens 28 and the seventh light guide plate lens 29 vary in a range from 0.002 mm to 0.0034 mm, for example. In this way, with respect to each of the height dimensions H2 and H3 of the sixth light guide plate lens 28 and the seventh light guide plate lens 29, a minimum value of approximately 0.002 mm (2 μm) is secured. As a result, sufficient ease of manufacturing can be secured when the second light guide plate 25 is manufactured by resin molding. In order to secure the minimum value of approximately 0.002 mm for each of the height dimensions H2 and H3 of the sixth light guide plate lens 28 and the seventh light guide plate lens 29, each of the third angle θ3 of the fourth inclined surface 28B and the fourth angle θ4 of the fifth inclined surface 29B is preferably 3° or greater. Note that the first angle θ1 of the first inclined surface 28A, the second angle θ2 of the second inclined surface 29A, the third angle θ3 of the fourth inclined surface 28B, and the fourth angle θ4 of the fifth inclined surface 29B are constant regardless of the position in the second light guide plate 25 in the X-axis direction.

As illustrated in FIGS. 3 and 7, each of the sixth light guide plate lens 28 and the seventh light guide plate lens 29 having the above-described configuration is disposed so as to be sandwiched between two of the fifth light guide plate lenses 27 that are adjacent to each other in the Y-axis direction. Therefore, the sixth light guide plate lenses 28 and the seventh light guide plate lenses 29 are repeatedly disposed in an alternate manner with the fifth light guide plate lenses 27 in the Y-axis direction. Maximum values of the respective height dimensions (protrusion dimensions from the second opposite main surface 25C) H2 and H3 of the sixth light guide plate lens 28 and the seventh light guide plate lens 29 are both set to be smaller than a height dimension of the fifth light guide plate lens 27. Therefore, even the sixth light guide plate lens 28 and the seventh light guide plate lens 29 located farthest from the second LED 24 in the X-axis direction do not protrude further toward the back side than the fifth light guide plate lens 27.

Here, Demonstration Experiment 1 was performed in order to acquire knowledge related to how light distribution changes when the first angle θ1 and the second angle θ2 formed by the first inclined surface 28A and the second inclined surface 29A of the sixth light guide plate lens 28 and the seventh light guide plate lens 29 of the second light guide plate 25 with respect to the X-axis direction are changed. In Demonstration Experiment 1, the backlight device 12 having the same configuration as that described before the present paragraph is used except for the configuration of the sixth light guide plate lens 28 and the seventh light guide plate lens 29. In Demonstration Experiment 1, the angles formed by the first inclined surface 28A and the second inclined surface 29A with respect to the X-axis direction were set to be equal to each other, and the angles were changed in a range from 36° to 60°. More specifically, in Demonstration Experiment 1, the angles formed by the first inclined surface 28A and the second inclined surface 29A with respect to the X-axis direction were set to 36°, 40°, 44°, 48°, 50°, 54°, and 60°. In the backlight device 12 in which the angles formed by the first inclined surface 28A and the second inclined surface 29A with respect to the X-axis direction were changed in such a manner, brightness of emission light when the second LED 24 was turned on and the first LED 13 was turned off was measured, and a graph regarding light distribution (brightness angle distribution) in the X-axis direction was produced.

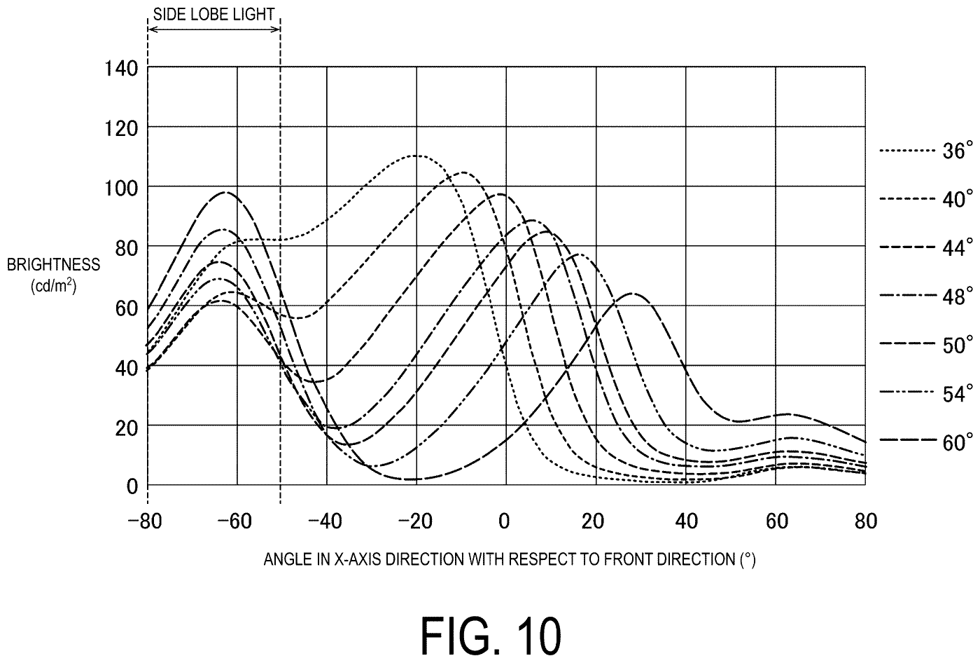

Experimental results of the light distribution in Demonstration Experiment 1 are as shown in FIG. 10. In a graph regarding the light distribution shown in FIG. 10, the horizontal axis indicates the angle (in units of “0”) in the X-axis direction with respect to the front direction (Z-axis direction), and the vertical axis indicates brightness (in units of “cd/m²”). Of the positive and negative symbols provided to the angles in the horizontal axis in FIG. 10, “− (negative)” refers to the left side in the X-axis direction with respect to 0° (front direction) when the backlight device 12 is viewed from the front, and “+ (positive)” refers to the right side in the X-axis direction with respect to 0° (front direction) when the backlight device 12 is viewed from the front.

The experimental results of Demonstration Experiment 1 will be described. According to FIG. 10, when the angles formed by the first inclined surface 28A and the second inclined surface 29A with respect to the X-axis direction were 36°, 40°, and 44° in the range from 36° to 60°, an angle at which peak brightness was obtained was “−”, and when the angles were 48°, 50°, 54°, and 60°, the angle at which the peak brightness was obtained was “+”. More specifically, when the angles formed by the first inclined surface 28A and the second inclined surface 29A with respect to the X-axis direction are 44°, the angle at which the peak brightness is obtained is closest to 0°. Therefore, when the angles formed by the first inclined surface 28A and the second inclined surface 29A with respect to the X-axis direction are 45°, it can be estimated that the angle at which the peak brightness is obtained is substantially 0°. Therefore, it can be said that when the angles formed by the first inclined surface 28A and the second inclined surface 29A with respect to the X-axis direction are smaller than 45°, the angle at which the peak brightness is obtained tends to be “−”, and when the angles formed by the first inclined surface 28A and the second inclined surface 29A with respect to the X-axis direction are larger than 45°, the angle at which the peak brightness is obtained tends to be “+”.

According to FIG. 10, it can be said that as the angles formed by the first inclined surface 28A and the second inclined surface 29A with respect to the X-axis direction are numerical values closer to 45°, the absolute value of the angle at which the peak brightness is obtained tend to be smaller (closer to) 0°. According to FIG. 10, it can be seen that when the angles formed by the first inclined surface 28A and the second inclined surface 29A with respect to the X-axis direction are 36° and 54°, the angle at which the peak brightness is obtained is approximately +20°. Further, according to FIG. 10, it can be said that the smaller the angles formed by the first inclined surface 28A and the second inclined surface 29A with respect to the X-axis direction, the higher the peak brightness tends to become. Further, when light emitted in a range from −80° to −50° in the X-axis direction with respect to the front direction is defined as “side lobe light”, it can be said that an amount of the side lobe light is minimum when the angles formed by the first inclined surface 28A and the second inclined surfaces 29A with respect to the X-axis direction are 44°, and the amount of side lobe light tends to increase when the angles are larger or smaller than 44°.

Next, in order to validate the advantages of the backlight device 12 and the liquid crystal display device 10 according to the present embodiment, the following Comparative Experiment 1 was performed. Next, using Example 1 and Comparative Example 1 described below, Comparative Experiment 1 was performed in order to acquire knowledge related to how light distribution changes when only the first LED 13 was turned on, when only the second LED 24 was turned on, and when both of the first LED 13 and the second LED 24 were turned on. In Example 1, the backlight device 12 having the same configuration as that described before Demonstration Experiment 1 was used, the first angle θ1 of the first inclined surface 28A provided in the sixth light guide plate lens 28 was set to 32°, and the second angle θ2 of the second inclined surface 29A provided in the seventh light guide plate lens 29 was set to 54°. In Comparative Example 1, the backlight device 12 having the same configuration as that described before Demonstration Experiment 1 was used except that the first angle θ1 of the first inclined surface 28A provided in the sixth light guide plate lens 28 was set to 27°, and the second angle θ2 of the second inclined surface 29A provided in the seventh light guide plate lens 29 was set to 58°. Specifically, in Comparative Experiment 1, using Example 1 and Comparative Example 1, brightness of emission light was measured in each of the case where the first LED 13 was turned on and the second LED 24 was turned off, the case where the second LED 24 was turned on and the first LED 13 was turned off, and the case where both of the first LED 13 and the second LED 24 were turned on, and a graph regarding the light distribution (brightness angle distribution) in the X-axis direction was produced.

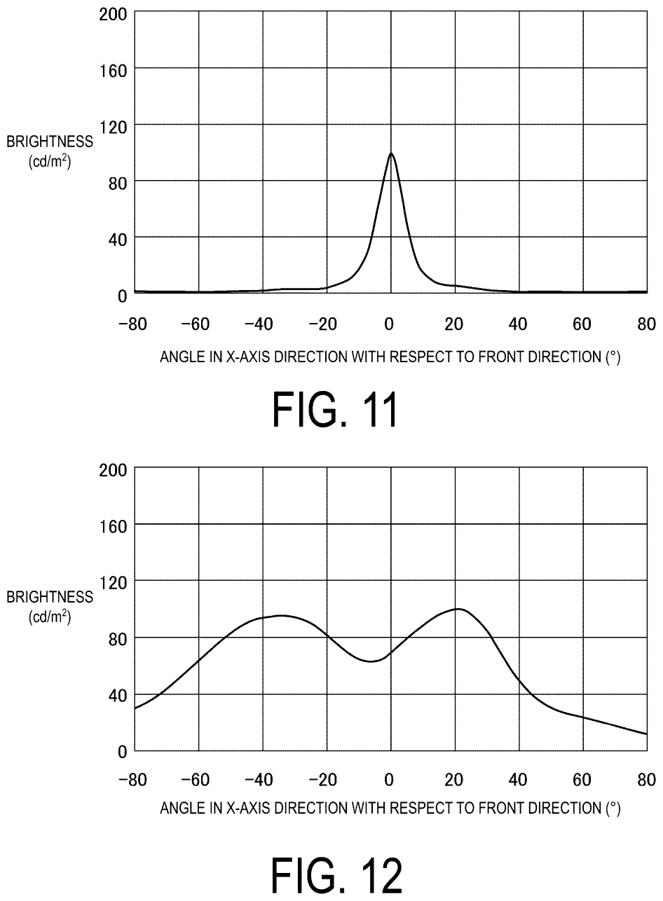

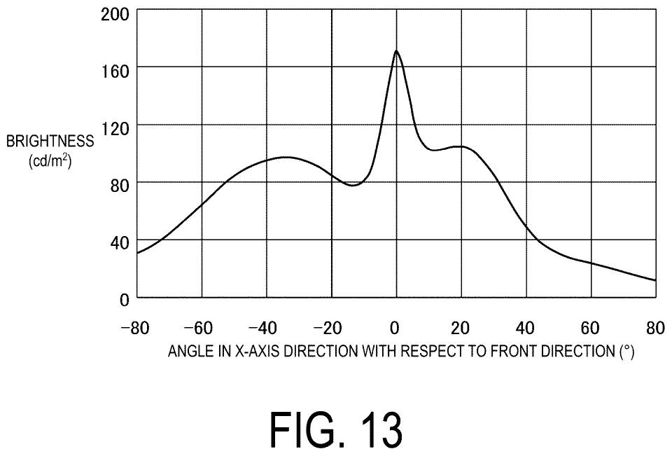

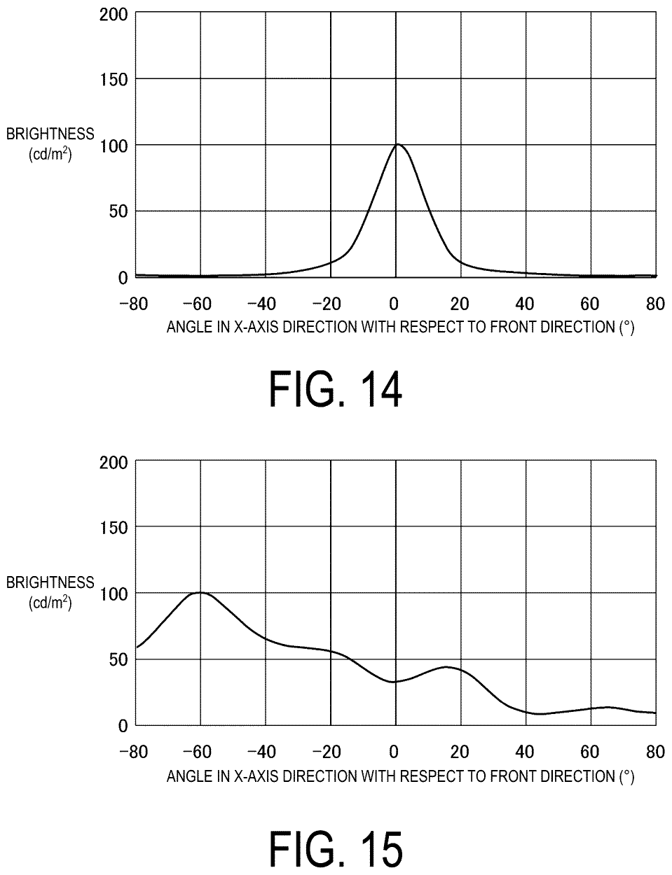

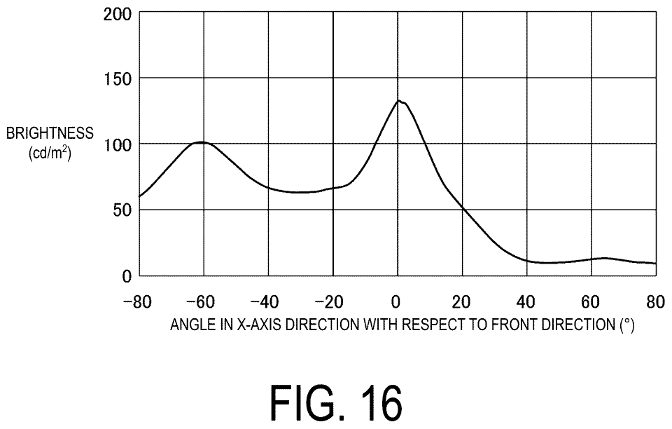

An experimental result of the light distribution in Comparative Experiment 1 is as shown in FIGS. 11 to 16. In graphs regarding the light distribution shown in FIGS. 11 to 16, the horizontal axis is the angle (in units of “0”) in the X-axis direction with respect to the front direction (Z-axis direction), and the vertical axis is brightness (in units of “cd/m²”). Positive and negative symbols provided to the angles in the horizontal axis in FIGS. 11 to 16 have the same meaning as the symbols provided to the horizontal axis in the graph in FIG. 11. FIGS. 11 to 13 show the experimental result of Comparative Example 1. FIGS. 14 to 16 show an experimental result of Example 1. FIGS. 11 to 14 each show the light distribution when the first LED 13 is turned on and the second LED 24 is turned off. FIGS. 12 to 15 each show the light distribution when the second LED 24 is turned on and the first LED 13 is turned off. FIGS. 13 and 16 each show the light distribution when both of the first LED 13 and the second LED 24 are turned on.

The experimental result of Comparative Experiment 1 will be described. First, according to the light distributions shown in FIGS. 11 and 14, when the first LED 13 was turned on and the second LED 24 was turned off, the peak brightness was substantially 0° and the emission angle range was approximately +10° in both Comparative Example 1 and Example 1. It can be said that the result reflects the fact that the emission angle range of light emitted from the first light guide plate 14 by turning on the first LED 13 is restricted to approximately ±10° by the first louver 18.

Next, according to the light distribution shown in FIG. 12, which is the experimental result of Comparative Example 1, when the second LED 24 is turned on and the first LED 13 is turned off, there are two peak brightnesses in the vicinity of −40° and in the vicinity of +20°. It is inferred that emission light in the vicinity of −40° is light reflected by the first inclined surface 28A, and emission light in the vicinity of +20° is light reflected by the second inclined surface 29A. According to the light distribution shown in FIG. 15, which is the experimental result of Example 1, when the second LED 24 is turned on and the first LED 13 is turned off, three peak brightnesses are present in the vicinity of −60°, −20°, and +20°. It is inferred that emission light in the vicinity of −20° is light reflected by the first inclined surface 28A, and emission light in the vicinity of +20° is light reflected by the second inclined surface 29A. Further, it is inferred that emission light in the vicinity of −60° is, for example, light (the side lobe light) having reached and emitted from the second light guide plate light emission main surface 25B, as a result of light having transmitted through the second inclined surface 29A while being refracted by the second inclined surface 29A, being refracted by the fourth inclined surface 28B upon being incident on the fourth inclined surface 28B. In this way, according to the light distributions shown in FIGS. 12 and 15, it can be said that, when the second LED 24 is turned on, emission light having a light distribution in which the peak brightnesses of the emission light are biased toward both the side opposite to the second LED 24 side in the X-axis direction and the second LED 24 side in the X-axis direction is emitted.

The light distribution shown in FIG. 13, which is the experimental result of Comparative Example 1, is a combination of the light distribution shown in FIG. 11 and the light distribution shown in FIG. 12, and the light distribution shown in FIG. 16, which is the experimental result of Example 1, is a combination of the light distribution shown in FIG. 14 and the light distribution shown in FIG. 15. According to the light distribution shown in FIG. 13, which is the experimental result of Comparative Example 1, when both the first LED 13 and the second LED 24 are turned on, the peak brightnesses are present at substantially 0° and in the vicinity of −40° and +20°, and the peak brightness is the highest at substantially 0°. However, according to the light distribution shown in FIG. 13, which is the experimental result of Comparative Example 1, when both the first LED 13 and the second LED 24 are turned on, the brightness locally decreases in the vicinity of −15° between the peak brightness at substantially 0° and the peak brightness in the vicinity of −40°, and the brightness also locally decreases in the vicinity of +15° between the peak brightness at substantially 0° and the peak brightness in the vicinity of −20°. In other words, in the light distribution shown in FIG. 13, the brightness in the vicinity of −15° is lower than the peak brightness in the vicinity of −40°, and the brightness in the vicinity of +15° is lower than the peak brightness in the vicinity of +20°. Therefore, in Comparative Example 1, in a viewing range of +20°, the local decrease in brightness occurs only in the vicinity of +15°, and thus there is a problem that viewing angle performance is poor.

In contrast, according to the light distribution shown in FIG. 16, which is the experimental result of Example 1, when both the first LED 13 and the second LED 24 are turned on, the peak brightnesses are present at approximately 0° and in the vicinity of −60°, and the peak brightness is the highest at substantially 0°. According to the light distribution shown in FIG. 16, which is the experimental result of Example 1, it can be seen that when both the first LED 13 and the second LED 24 are turned on, the brightness tends to continuously decrease from the peak brightness at substantially 0° toward ±20°, and no change in brightness occurs which causes the brightness to increase in the middle of the range. In other words, in Example 1, it can be said that an occurrence of the local decrease in brightness is prevented in the viewing range of ±20° and excellent viewing angle performance is obtained.

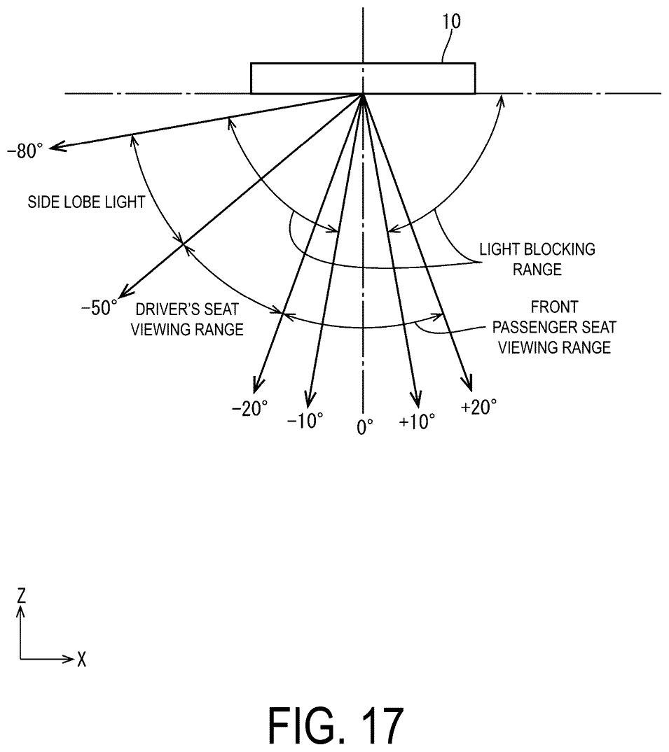

FIG. 17 is illustrated for a supplemental description of the graphs shown in FIGS. 11 to 16. FIG. 17 is a diagram for describing the angle in the X-axis direction with respect to the front direction in the liquid crystal display device 10 installed in front of the front passenger seat of the passenger vehicle in which the driver's seat is located to the left side of the front passenger seat. FIG. 17 illustrates light blocking ranges (+10° to +90° and −10° to)−90° in which light is blocked by the first louver 18, a driver's seat viewing range (−20° to −50°) that is a viewing range when the liquid crystal display device 10 is viewed from the driver's seat located to the left side of the front passenger seat, a front passenger seat viewing range (−20° to +20°) that is a viewing range when the liquid crystal display device 10 is viewed from the front passenger seat located to the right side of the driver's seat and in front of the liquid crystal display device 10, and an emission range (−80° to −50°) of the side lobe light emitted, on the driver's seat side, to a range outside both the driver's seat viewing range and the front passenger seat viewing range.

According to FIGS. 11, 14, and 17, in both Comparative Example 1 and Example 1, when the first LED 13 is turned on and the second LED 24 is turned off, the peak brightness is substantially at 0°, and the emission angle range is approximately ±10°. Thus, it can be said that a display image of the liquid crystal display device 10 can be visually recognized from the front passenger seat located at 0° in an excellent manner, while making the image displayed on the liquid crystal display device 10 almost invisible from the driver's seat. According to FIGS. 12, 15, and 17, in both Comparative Example 1 and Example 1, when the second LED 24 is turned on and the first LED 13 is turned off, the display image of the liquid crystal display device 10 cannot be visually recognized in an excellent manner particularly from the front passenger seat. According to FIGS. 13 and 17, in Comparative Example 1, when both the first LED 13 and the second LED 24 are turned on, brightness of 50 cd/m² or greater is secured over the entire region in both the front passenger seat viewing range from −20° to +20° and the driver's seat viewing range from −50° to −20°. Thus, the display image of the liquid crystal display device 10 can be visually recognized from both the driver's seat and the front passenger seat, but the viewing angle becomes narrow from the front passenger seat due to the local decrease in brightness present in the vicinity of +15°. According to FIGS. 16 and 17, when both the first LED 13 and the second LED 24 are turned on in Example 1, brightness of 50 cd/m² or greater is secured over the entire region in both the front passenger seat viewing range from −20° to +20° and the driver's seat viewing range from −50° to −20°. Thus, the display image of the liquid crystal display device 10 can be visually recognized from both the driver's seat and the front passenger seat. In particular, since no local decrease in brightness occurs in the front passenger seat viewing range, it can be said that widening of the viewing angle is achieved in the front passenger seat.

As described above, the backlight device (illumination device) 12 according to the present embodiment includes the first LED (first light source) 13, the first light guide plate 14 that at least includes a part of the outer peripheral end surface of the first light guide plate 14 as the first light incident end surface (first end surface) 14A facing the first LED 13 and on which light is incident, one of the main surfaces of the first light guide plate 14 as the first light guide plate light emission main surface (first main surface) 14B that emits light, and the other main surface of the first light guide plate 14 as the first opposite main surface (second main surface) 14C. The backlight device 12 further includes the first louver (first sheet) 18 that includes one of the main surfaces of the first louver 18 as the first light incident main surface (third main surface) 18A facing the first light guide plate light emission main surface 14B and on which light is incident, and the other main surface of the first louver 18 as the first light emission main surface (fourth main surface) 18B that emits light, the second LED (second light source) 24, and the second light guide plate 25 that includes at least a part of the outer peripheral end surface of the second light guide plate 25 as the second light incident end surface (first end surface) 25A facing the second LED 24 and on which light is incident, one of the main surfaces of the second light guide plate 25 as the second light guide plate light emission main surface (fifth main surface) 25B that emits light, and the other main surface of the second light guide plate 25 as the second opposite main surface (sixth main surface) 25C disposed facing the first light emission main surface 18B. The first louver 18 at least includes the two first light blocking portions 18C that are disposed with an interval therebetween in the first direction including a direction from the first LED 13 toward the first light guide plate 14 and that block light, and the first light-transmitting portion 18D that is disposed between the two first light blocking portions 18C and that transmits light. The second opposite main surface 25C of the second light guide plate 25 includes the first inclined surface 28A and the second inclined surface 29A each having the inclination rising from the side opposite to the second LED 24 toward the second LED 24 side in the first direction. The angle formed by the first inclined surface 28A with respect to the first direction is the first angle θ1 that is greater than 27°, and the angle formed by the second inclined surface 29A with respect to the first direction is the second angle θ2 that is greater than the first angle θ1 and smaller than 58°.

In this way, light emitted from the first LED 13 and incident on the first light incident end surface 14A of the first light guide plate 14 propagates inside the first light guide plate 14, and is also emitted from the first light guide plate light emission main surface 14B and incident on the first light incident main surface 18A of the first louver 18. The light incident on the first light incident main surface 18A of the first louver 18 transmits through the first light-transmitting portion 18D disposed between the two first light blocking portions 18C, and is emitted from the first light emission main surface 18B. The emission angle of the light emitted from the first light emission main surface 18B is restricted by the two first light blocking portions 18C. When the light emitted from the first light emission main surface 18B is incident on the second opposite main surface 25C of the second light guide plate 25, the light is emitted from the second light guide plate light emission main surface 25B. The light emitted from the second light guide plate light emission main surface 25B has an angle range restricted by the first light blocking portions 18C of the first louver 18, and thus is made less likely to be emitted outside the restricted angle range. In this way, when the first LED 13 is turned on and the second LED 24 is turned off, the light can be selectively emitted in the emission angle range that is restricted centered on the normal direction of the second light guide plate light emission main surface 25B, namely, centered on the front direction. light emission main surface

At least a part of the light emitted from the second LED 24 and incident on the second light incident end surface 25A of the second light guide plate 25 is incident on the first inclined surface 28A and the second inclined surface 29A provided on the second opposite main surface 25C in the process of propagating inside the second light guide plate 25, and then reflected by or transmitted through the first inclined surface 28A and the second inclined surface 29A. The traveling direction of the light reflected by the first inclined surface 28A and the second inclined surface 29A becomes a direction corresponding to the angles formed by the first inclined surface 28A and the second inclined surface 29A with respect to the first direction. When light reflected by the first inclined surface 28A having the first angle θ1 smaller than the second angle θ2 with respect to the first direction is emitted from the second light guide plate light emission main surface 25B, the light is likely to travel toward the side opposite to the second LED 24 side in the first direction with respect to the front direction. On the other hand, when light reflected by the second inclined surface 29A having the second angle θ2 greater than the first angle θ1 with respect to the first direction is emitted from the second light guide plate light emission main surface 25B, the light is likely to travel toward the second LED 24 side in the first direction with respect to the front direction. Therefore, when the second LED 24 is turned on, emission light having a brightness angle distribution in which the peak brightnesses of the emission light are biased toward both the side opposite to the second LED 24 side in the first direction and the second LED 24 side in the first direction can be supplied. In this way, brightness of emission light traveling in a direction inclined with respect to the front direction can be sufficiently secured, and in addition, the widening of the viewing angle is favorably achieved due to the expansion of the emission angle range of the emission light.

Further, since the first angle θ1 of the first inclined surface 28A is greater than 27°, when the light reflected by the first inclined surface 28A is emitted from the second light guide plate light emission main surface 25B, the light travels in a direction closer to the front direction as compared to when the first angle θ1 is set to 27° or less. Since the second angle θ2 of the second inclined surface 29A is smaller than 58°, when the light reflected by the second inclined surface 29A is emitted from the second light guide plate light emission main surface 25B, the light travels in a direction closer to the front direction as compared to when the second angle θ2 is set to 58° or greater. Therefore, when both the first LED 13 and the second LED 24 are turned on, in the brightness angle distribution of the light emitted from the second light guide plate light emission main surface 25B, brightness tends to become lower toward wide-angle sides with respect to the front direction, and the local decrease in brightness is less likely to occur in the middle of the range. As described above, it is possible to make it less likely for the unevenness of brightness to occur while achieving the widening of the viewing angle.

Further, the second opposite main surface 25C of the second light guide plate 25 includes the third inclined surface 31 having the inclination rising from the second LED 24 toward the side opposite to the second LED 24 in the first direction. When light traveling toward the second LED 24 in the first direction inside the second light guide plate 25 is incident on the third inclined surface 31 and refracted, the light travels toward the side opposite to the second LED 24 side in the first direction with respect to the front direction. In this way, brightness of emission light traveling in a direction inclined with respect to the front direction can be further improved. Further, when light traveling away from the second LED 24 in the first direction inside the second light guide plate 25 is incident on the third inclined surface 31 and refracted, the light is guided so as to travel farther away from the second LED 24. In this way, the light emitted from the second light guide plate light emission main surface 25B is less likely to be biased toward the second LED 24 side in the first direction.

Further, the liquid crystal display device (display device) 10 according to the present embodiment includes the backlight device 12 described above, and the liquid crystal panel (display panel) 11 configured to perform display by using light from the backlight device 12. According to the liquid crystal display device 10 having such a configuration, in the backlight device 12, emission of light outside the restricted angle range is suppressed, and brightness of emission light traveling in a direction inclined with respect to the front direction is improved. Further, the widening of the viewing angle is achieved due to the expansion of the emission angle range of the emission light, and also the unevenness of brightness is caused to be less likely to occur. Thus, display can be achieved with excellent display quality.

### Second Embodiment

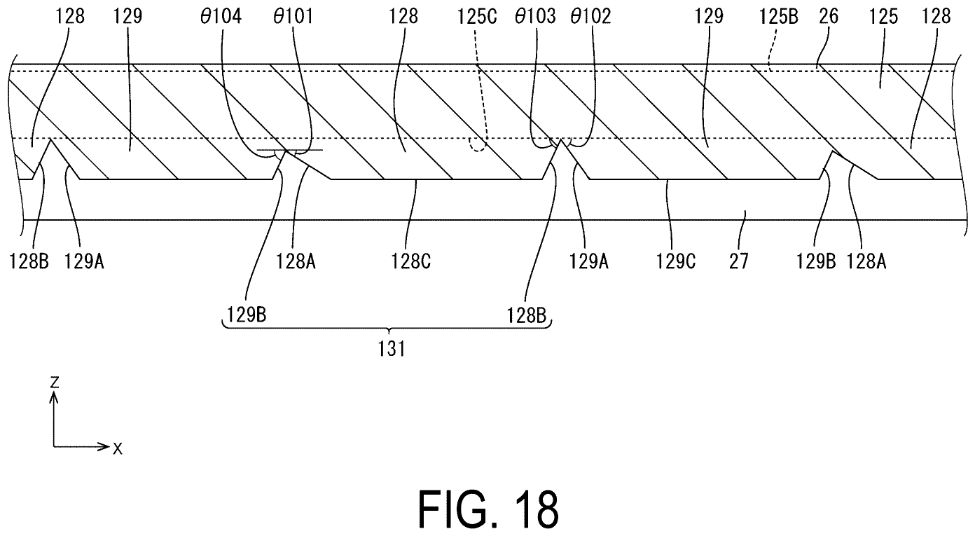

A second embodiment will be described with reference to FIG. 18 to FIG. 22. In the second embodiment, a case will be described in which configurations of a third inclined surface 131 and the like are changed. Further, repetitive descriptions of structures, actions, and effects similar to those of the first embodiment described above will be omitted.

As illustrated in FIG. 18, the third inclined surface 131 provided in a second light guide plate 125 according to the present embodiment forms an angle of 40° or greater with respect to the X-axis direction (first direction). With respect to a fourth inclined surface 128B included in the third inclined surface 131, a third angle θ103, which is an angle formed with respect to the X-axis direction, is 40° or greater, and is, for example, approximately 65°. With respect to a fifth inclined surface 129B included in the third inclined surface 131, a fourth angle θ104, which is an angle formed with respect to the X-axis direction, is 40° or greater, and is, for example, approximately 65°. Therefore, the fourth inclined surface 128B and the fifth inclined surface 129B are configured such that the third angle θ103 and the fourth angle θ104 are equal to each other. Note that, as in the first embodiment described above, a first angle θ101 of a first inclined surface 128A is approximately 32°, and a second angle θ102 of a second inclined surface 129A is approximately 54°. Further, the third plane 32 (see FIG. 6) described in the first embodiment is not provided on a second opposite main surface 125C of the second light guide plate 125 according to the present embodiment. Thus, in the present embodiment, the first inclined surface 128A and the second inclined surface 129A are disposed so as to be directly connected to each other.

As illustrated in FIG. 18, when light emitted from the second LED 24 and introduced into the second light guide plate 125 is incident on the second inclined surface 129A in a process of propagating inside the second light guide plate 125, most of the light is reflected but a part of the light transmits through the second inclined surface 129A. The light transmitted through the second inclined surface 129A is incident on the fourth inclined surface 128B facing the second inclined surface 129A while being refracted by the second inclined surface 129A, is refracted there, and is directed to a second light guide plate light emission main surface 125B. Here, since the third angle θ103 of each of the fourth inclined surfaces 128B is 40° or greater as described above, incident light can be angled such that most of the light having reached the second light guide plate light emission main surface 125B is totally reflected by the second light guide plate light emission main surface 125B, as a result of the light transmitting through the second inclined surface 129A and being refracted by the fourth inclined surface 128B. In this way, most of the light refracted by the fourth inclined surface 128B and then having reached the second light guide plate light emission main surface 125B can be totally reflected and caused to travel toward the second opposite main surface 125C. As a result, it is possible to reduce the side lobe light emitted from the second light guide plate light emission main surface 125B and traveling in a direction inclined to the side opposite to the second LED 24 side in the X-axis direction with respect to the front direction.

On the other hand, in the case where the first LED 13 is turned on while the second LED 24 is turned off (see FIG. 1), when light emitted from the first light guide plate light emission main surface 14B of the first light guide plate 14 transmits through the first light-transmitting portion 18D of the first louver 18, the light is incident on the first inclined surface 128A, the second inclined surface 129A, and the third inclined surface 131 provided on the second opposite main surface 125C of the second light guide plate 125, as illustrated in FIG. 18. Of the light, the light incident on the fourth inclined surface 128B included in the third inclined surface 131 is refracted by the fourth inclined surface 128B in a direction corresponding to the third angle θ103. In the present embodiment, since the third angle θ103 is set to approximately 65° and is 65° or greater, it is possible to reduce a ratio of light traveling toward the side (left side in FIG. 18) opposite to the second LED 24 side in the X-axis direction in the light emitted from the second light guide plate light emission main surface second LED 125B, as compared to when the third angle θ103 is smaller than 65°. In particular, of the light traveling toward the side opposite to the second LED 24 side in the X-axis direction, a ratio of light traveling in the direction of 45° with respect to the X-axis direction in the light emitted from the second light guide plate light emission main surface 125B can be made 2.5% or less. As a result, the light emitted outside the angle range restricted by the first light blocking portions 18C (see FIG. 2) of the first louver 18 is effectively prevented from being visually recognized.

Further, when the first LED 13 is turned on while the second LED 24 is turned off (see FIG. 1), light emitted from the first louver 18 is incident on the fourth inclined surface 128B and the fifth inclined surface 129B provided on the second opposite main surface 125C of the second light guide plate 125. Then, the light incident on the fourth inclined surface 128B is refracted by the fourth inclined surface 128B in the direction corresponding to the third angle θ103, and the light incident on the fifth inclined surface 129B is refracted by the fifth inclined surface 129B in a direction corresponding to the fourth angle θ104. In the present embodiment, since the fourth angle θ104 of the fifth inclined surface 129B is equal to the third angle θ103 of the fourth inclined surface 128B, degrees of refraction imparted to the respective light beams incident on the fourth inclined surface 128B and the fifth inclined surface 129B from the first louver 18 side become equal to each other. As a result, the respective light beams incident on the fourth inclined surface 128B and the fifth inclined surface 129B from the first louver 18 side and refracted by the fourth inclined surface 128B and the fifth inclined surface 129B are less likely to vary in terms of the traveling direction when emitted from the second light guide plate light emission main surface 125B.

Here, Demonstration Experiment 2 was performed in order to acquire knowledge related to how light distribution changes when the third angle θ103 and the fourth angle θ104 are changed, the third angle θ103 and the fourth angle θ104 being the angles respectively formed by the fourth inclined surface 128B and the fifth inclined surface 129B of a sixth light guide plate lens 128 and a seventh light guide plate lens 129 of the second light guide plate 125 with respect to the X-axis direction. In Demonstration Experiment 2, the backlight device 12 having the same configuration as that described before the present paragraph is used except for configurations of the sixth light guide plate lens 128 and the seventh light guide plate lens 129. In Demonstration Experiment 2, the angles formed by the first inclined surface 128A and the second inclined surface 129A with respect to the X-axis direction were set to be equal to each other and fixed to 54°, and then the angles formed by the fourth inclined surface 128B and the fifth inclined surface 129B with respect to the X-axis direction were set to be equal to each other and changed in a range from 3° to 60°. More specifically, in Demonstration Experiment 2, the angles formed by the fourth inclined surface 128B and the fifth inclined surface 129B with respect to the X-axis direction were set to 3°, 10°, 20°, 40°, and 60°. In the backlight device 12 having the angles formed by the fourth inclined surface 128B and the fifth inclined surface 129B with respect to the X-axis direction changed in the above-described manner, brightness of emission light when the second LED 24 was turned on and the first LED 13 was turned off was measured, and a graph regarding light distribution (brightness angle distribution) in the X-axis direction was produced.

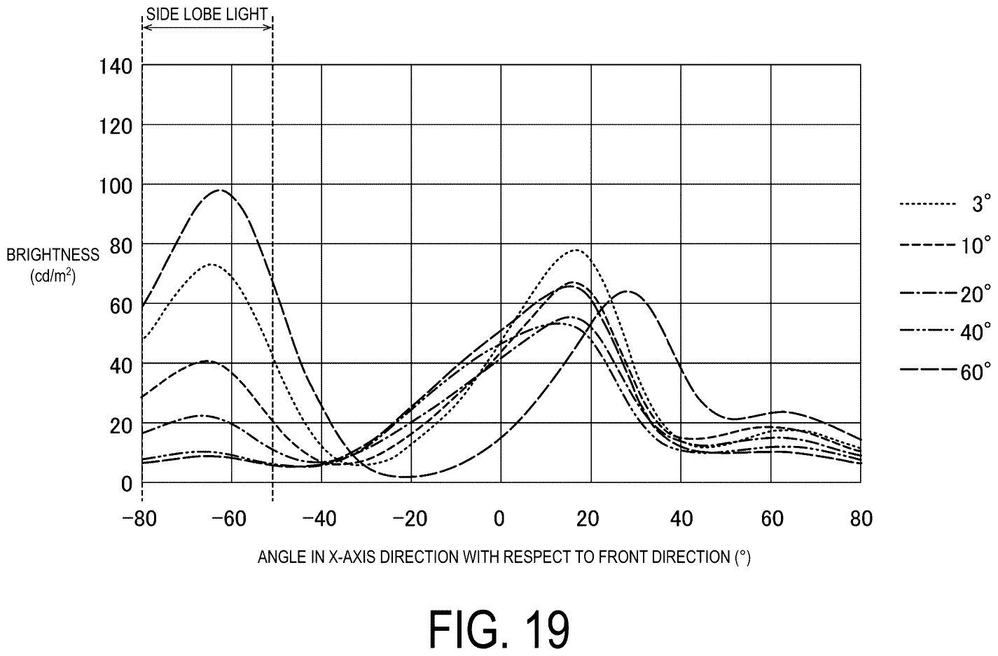

An experimental result on the light distribution in Demonstration Experiment 2 is as shown in FIG. 19. In a graph regarding the light distribution shown in FIG. 19, the horizontal axis is the angle (in units of “0”) in the X-axis direction with respect to the front direction (Z-axis direction), and the vertical axis is brightness (in units of “cd/m²”). Positive and negative symbols provided to the angles in the horizontal axis in FIG. 19 have the same meaning as the symbols provided to the horizontal axis in the graph in FIG. 10 described in Demonstration Experiment 1 of the first embodiment.

The experimental result of Demonstration Experiment 2 will be described. According to FIG. 19, it can be seen that an amount of the side lobe light (light emitted having the angle in the X-axis direction with respect to the front direction in the range from −80° to)−50° changes in accordance with the angles formed by the fourth inclined surface 128B and the fifth inclined surface 129B with respect to the X-axis direction. Specifically, when the angles formed by the fourth inclined surface 128B and the fifth inclined surface 129B with respect to the X-axis direction are 20° or less, brightness of the side lobe light is higher than 20 cd/m², and as the angles formed by the fourth inclined surface 128B and the fifth inclined surface 129B with respect to the X-axis direction become smaller, the brightness of the side lobe light tends to increase. It can be seen that when the angles formed by the fourth inclined surface 128B and the fifth inclined surface 129B with respect to the X-axis direction are 40° or greater, the brightness of the side lobe light becomes lower than 10 cd/m². Further, it can be seen that the brightness of the side lobe light does not change so much when the angles formed by the fourth inclined surface 128B and the fifth inclined surface 129B with respect to the X-axis direction are either 40° or 60°. Therefore, it can be said that when the angles formed by the fourth inclined surface 128B and the fifth inclined surface 129B with respect to the X-axis direction are 40° or greater, the side lobe light can be favorably reduced.

Next, in order to validate the advantages of the backlight device 12 and the liquid crystal display device 10 according to the present embodiment, Comparative Experiment 2 similar to Comparative Experiment 1 of the first embodiment was performed. In Comparative Experiment 2, Example 2 described below was used. Example 2 is the backlight device 12 having the same configuration as that described before Demonstration Experiment 2 described above, in which the first angle θ101 of the first inclined surface 128A is 32°, the second angle θ102 of the second inclined surface 129A is 54°, the third angle θ103 of the fourth inclined surface 128B is 65°, and the fourth angle θ104 of the fifth inclined surface 129B is 65°. In Comparative Experiment 2, using Example 2, brightness of emission light was measured in each of the case where the first LED 13 was turned on and the second LED 24 was turned off, the case where the second LED 24 was turned on and the first LED 13 was turned off, and the case where both of the first LED 13 and the second LED 24 were turned on, and a graph regarding light distribution (brightness angle distribution) in the X-axis direction was produced.

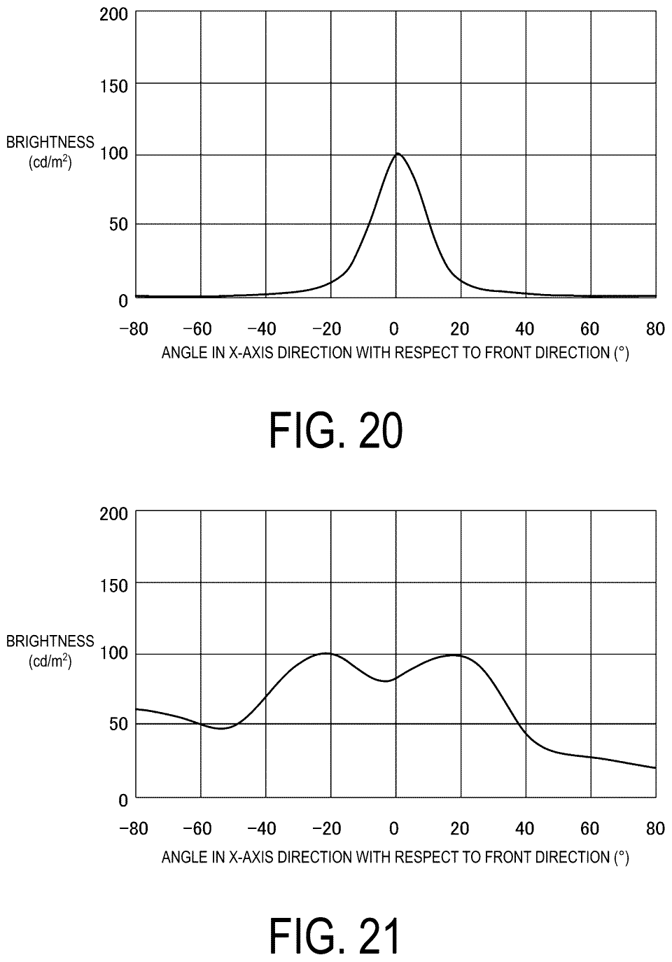

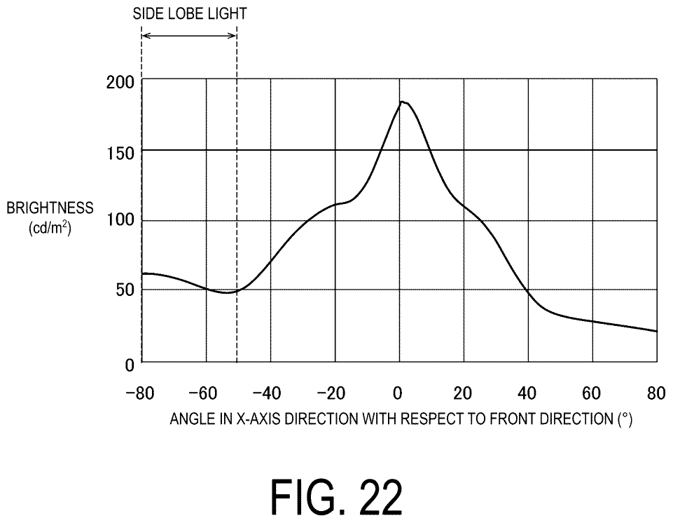

An experimental result on the light distribution in Comparative Experiment 2 is as shown in FIGS. 20 to 22. In graphs regarding the light distribution shown in FIGS. 20 to 22, the horizontal axis is the angle (in units of “0”) in the X-axis direction with respect to the front direction (Z-axis direction), and the vertical axis is brightness (in units of “cd/m²”). Positive and negative symbols provided to the angles in the horizontal axis in FIGS. 20 to 22 have the same meaning as the symbols provided to the horizontal axis in the graph in FIG. 10 described in Demonstration Experiment 1 of the first embodiment. FIGS. 20 to 22 show the experimental result of Example 2. FIG. 20 shows the light distribution when the first LED 13 is turned on and the second LED 24 is turned off. FIG. 21 shows the light distribution when the second LED 24 is turned on and the first LED 13 is turned off. FIG. 22 illustrates the light distribution when both of the first LED 13 and the second LED 24 are turned on.

The experimental result of Comparative Experiment 2 will be described while appropriately comparing it with the experimental result of Comparative Experiment 1 (FIGS. 11 to 16). First, according to the light distribution in FIG. 20, which is the experimental result of Example 2, when the first LED 13 is turned on and the second LED 24 is turned off, the peak brightness was at substantially 0°, and the emission angle range was approximately ±10°. This result is substantially the same as the experimental result according to Example 1 of Comparative Experiment 1 (see FIG. 14).

Next, according to the light distribution shown in FIG. 21, which is the experimental result of Example 2, when the second LED 24 is turned on and the first LED 13 is turned off, there are two peak brightnesses in the vicinity of −20° and +20°. It is inferred that the emission light in the vicinity of −20° is light reflected by the first inclined surface 128A, and the emission light in the vicinity of +20° is light reflected by the second inclined surface 129A. In the light distribution shown in FIG. 21, which is the experimental result of Example 2, compared to the experimental result (see FIG. 15) according to Example 1 of Comparative Experiment 1, the brightness is high in a range from −40° to +40°, whereas the brightness is significantly low in a range from −80° to −50°.

The light distribution shown in FIG. 22, which is the experimental result of Example 2, is a combination of the light distribution in FIG. 20 and the light distribution in FIG. 21. According to the light distribution shown in FIG. 22, when both the first LED 13 and the second LED 24 are turned on, the peak brightness is present at approximately 0°, and the brightness tends to decrease as the absolute value of the angle increases (as the angle moves away from 0° on the horizontal axis of FIG. 22) except for a part of the range (a range from −60° to)−80°. In the light distribution shown in FIG. 22, which is the experimental result of Example 2, compared to the experimental result (see FIG. 16) according to Example 1 of Comparative Experiment 1, the brightness is high in the range of −40° to +40°, whereas the brightness is significantly low in the range from −80° to −50°. It is inferred this is because, in Example 2, light transmitted through the second inclined surface 129A is refracted by the fourth inclined surface 128B having the third angle θ103 of 65° and most of the light is totally reflected by the second light guide plate light emission main surface 125B, so that the side lobe light emitted in the range from −80° to −50° is significantly reduced and light emitted in a range from −50° to +40° is increased. Further, it can be said that in Example 2, as in Example 1, an occurrence of the local decrease in brightness is prevented in the viewing range of +20° (the front passenger seat viewing range in FIG. 17), and excellent viewing angle performance is obtained.

As described above, according to the present embodiment, the third inclined surface 131 includes the fourth inclined surface 128B disposed so as to face the second inclined surface 129A with an interval therebetween, and the third angle θ103 of the fourth inclined surface 128B with respect to the first direction is 40° or greater. The light transmitted through the second inclined surface 129A is incident on the fourth inclined surface 128B facing the second inclined surface 129A while being refracted by the second inclined surface 129A, is refracted there, and is directed to the second light guide plate light emission main surface 125B. Since the third angle θ103 of the fourth inclined surface 128B is 40° or greater, the incident light can be angled such that most of the light having reached the second light guide plate light emission main surface 125B is totally reflected by the second light guide plate light emission main surface 125B. In this way, most of the light refracted by the fourth inclined surface 128B and then having reached the second light guide plate light emission main surface 125B can be totally reflected and caused to travel toward the second opposite main surface 125C. As a result, it is possible to reduce the side lobe light emitted from the second light guide plate light emission main surface 125B and traveling in a direction inclined to the side opposite to the second LED 24 side in the first direction with respect to the front direction.

Further, the third angle θ103 of the fourth inclined surface 128B is 65° or greater. In the case where the first LED 13 is turned on while the second LED 24 is turned off, when the light emitted from the first light guide plate light emission main surface 14B of the first light guide plate 14 transmits through the first light-transmitting portion 18D of the first louver 18, the light is incident on the first inclined surface 128A, the second inclined surface 129A, and the fourth inclined surface 128B provided on the second opposite main surface 125C of the second light guide plate 125. Of the light, the light incident on the fourth inclined surface 128B is refracted in the direction corresponding to the third angle θ103. Then, when the third angle θ103 is set to 65° or greater, the ratio of the light traveling toward the side opposite to the second LED 24 side in the first direction in the light emitted from the second light guide plate light emission main surface second 125B can be reduced as compared to when the third angle θ103 is smaller than 65°. In particular, among the light traveling toward the side opposite to the second LED 24 side in the first direction, the ratio of the light traveling in the direction of 45° with respect to the first direction in the light emitted from the second light guide plate light emission main surface 125B can be made 2.5% or less. As a result, the light emitted outside the angle range restricted by the first light blocking portions 18C of the first louver 18 is effectively prevented from being visually recognized.

Further, the third inclined surface 131 includes the fourth inclined surface 128B disposed so as to face the second inclined surface 129A with an interval therebetween and the fifth inclined surface 129B disposed so as to face the first inclined surface 128A with an interval therebetween, and the fourth angle θ104, which is an angle with respect to the first direction, of the fifth inclined surface 129B is equal to the third angle θ103, which is an angle with respect to the first direction, of the fourth inclined surface 128B. In the case where the first LED 13 is turned on while the second LED 24 is turned off, when the light emitted from the first light guide plate light emission main surface 14B of the first light guide plate 14 transmits through the first light-transmitting portion 18D of the first louver 18, the light is incident on the first inclined surface 128A, the second inclined surface 129A, the fourth inclined surface 128B, and the fifth inclined surface 129B provided on the second opposite main surface 125C of the second light guide plate 125. Of the light, the light incident on the fourth inclined surface 128B is refracted in the direction corresponding to the third angle θ103, and the light incident on the fifth inclined surface 129B is refracted in the direction corresponding to the fourth angle θ104. Here, since the fourth angle θ104 of the fifth inclined surface 129B is equal to the third angle θ103 of the fourth inclined surface 128B, the degrees of refraction imparted to the respective light beams incident on the fourth inclined surface 128B and the fifth inclined surface 129B from the first louver 18 side become equal to each other. As a result, the respective light beams incident on the fourth inclined surface 128B and the fifth inclined surface 129B from the first louver 18 side and refracted by the fourth inclined surface 128B and the fifth inclined surface 129B are less likely to vary in terms of the traveling direction when emitted from the second light guide plate light emission main surface 125B.

### Third Embodiment

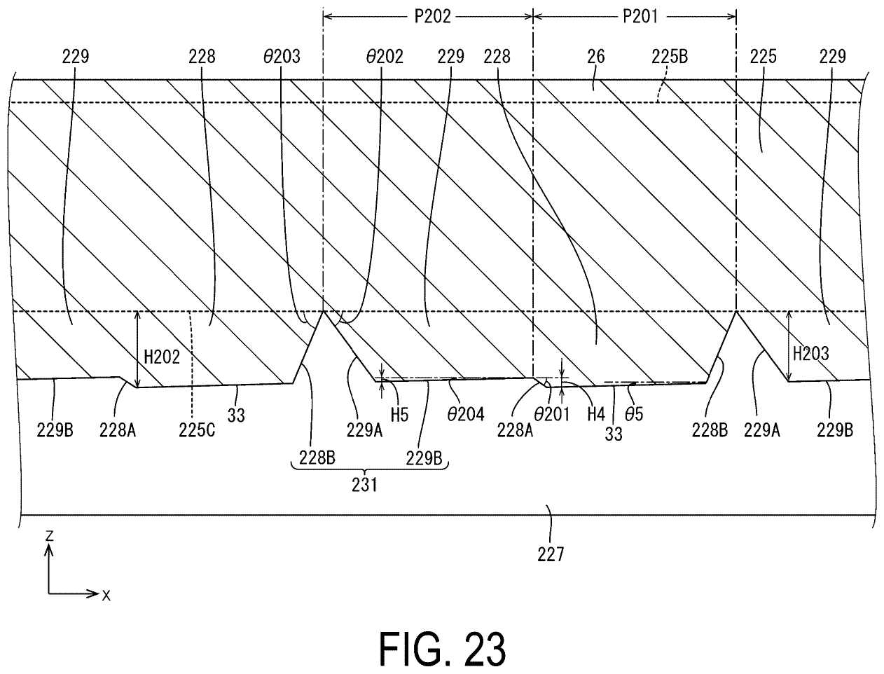

A third embodiment will be described with reference to FIGS. 23 to 30. In the third embodiment, a case will be described in which configurations of a sixth light guide plate lens 228, a seventh light guide plate lens 229, and the like are changed from those of the second embodiment described above. Further, repetitive descriptions of structures, actions, and effects similar to those of the second embodiment described above will be omitted.

As illustrated in FIG. 23, the sixth light guide plate lens 228 according to the present embodiment has a sixth inclined surface 33 located between a first inclined surface 228A and a fourth inclined surface 228B in the X-axis direction (first direction), in addition to the first inclined surface 228A and the fourth inclined surface 228B. The sixth inclined surface 33 has an inclination rising from the side opposite (left side in FIG. 23) to the second LED 24 side in the X-axis direction toward the second LED 24 side (right side in FIG. 23). In other words, the sixth inclined surface 33 is included in a third inclined surface 231. The sixth light guide plate lens 228 has the fourth inclined surface 228B and the sixth inclined surface 33, which are included in the third inclined surface 231. The sixth inclined surface 33 has a gradient such that the thickness of the sixth light guide plate lens 228 is continuously and gradually increased from the second LED 24 side toward the side opposite to the second LED 24 side in the X-axis direction. Then, a fifth angle θ5 formed by the sixth inclined surface 33 with respect to the X-axis direction is, for example, approximately 1.4°. In contrast, a third angle θ203 of the fourth inclined surface 228B is 67° or greater, and is, for example, approximately 67°. In the present embodiment, a first angle θ201 of the first inclined surface 228A is, for example, approximately 33°. Further, the sixth light guide plate lens 228 according to the present embodiment is not provided with the first plane 28C (see FIG. 6) described in the first embodiment.

As illustrated in FIG. 23, the seventh light guide plate lens 229 according to the present embodiment does not have the second plane 29C (see FIG. 6) described in the first embodiment, and is disposed such that a second inclined surface 229A and a fifth inclined surface 229B are directly connected to each other. A fourth angle θ204 of the fifth inclined surface 229B is, for example, approximately 1.4°. Therefore, the fourth angle θ204 of the fifth inclined surface 229B is smaller than the third angle θ203. Further, the fourth angle θ204 and the fifth angle θ5, which are angles respectively formed by the fifth inclined surface 229B and the sixth inclined surface 33 with respect to the X-axis direction, are equal to each other. Note that, as in the first embodiment described above, a second angle θ202 of the second inclined surface 229A is approximately 54°.

As illustrated in FIG. 23, array pitches P201 and P202 of the sixth light guide plate lens 228 and the seventh light guide plate lens 229 in the X-axis direction are equal to each other, and are, for example, approximately 0.045 mm. A height dimension (protruding length from a second opposite main surface 225C) H₂O₂ of the sixth light guide plate lens 228 is, for example, approximately 0.0054 mm. Further, of the sixth light guide plate lens 228, a height dimension H4 from an upper end position of the first inclined surface 228A (an intersection position between the first inclined surface 228A and the fifth inclined surface 229B) to a lower end position of the first inclined surface 228A (an intersection position between the first inclined surface 228A and the sixth inclined surface 33) is, for example, approximately 0.0021 mm. A height dimension H203, from the second opposite main surface 225C, of the seventh light guide plate lens 229 is smaller than the height dimension H₂O₂ of the sixth light guide plate lens 228, and is, for example, approximately 0.0043 mm. Further, of the seventh light guide plate lens 229, a height dimension H5 from an upper end position of the fifth inclined surface 229B (an intersection position between the first inclined surface 228A and the fifth inclined surface 229B) to a lower end position of the fifth inclined surface 229B (an intersection position between the second inclined surface 229A and the fifth inclined surface 229B) is, for example, approximately 0.001 mm.

In the case where the first LED 13 is turned on while the second LED 24 is turned off (see FIG. 1), when the light emitted from the first light guide plate light emission main surface 14B of the first light guide plate 14 transmits through the first light-transmitting portion 18D of the first louver 18, the light is incident on the second opposite main surface 225C of the second light guide plate 225. At the second opposite main surface 225C, light incident on the fourth inclined surface 228B is refracted in a direction corresponding to the third angle θ203. Then, in the present embodiment, since the third angle θ203 is approximately 67° and is 67° or greater, a ratio of light traveling toward the side opposite to the second LED 24 side in the X-axis direction in the light emitted from the second light guide plate light emission main surface 225B can be further reduced as compared to when the third angle θ203 is 65° or greater and smaller than 67°. In particular, of the light traveling toward the side opposite to the second LED 24 side in the X-axis direction, a ratio of light traveling in the direction of 45° with respect to the X-axis direction in the light emitted from the second light guide plate light emission main surface 225B can be made 2.3% or less. As a result, the light emitted outside the angle range restricted by the first light blocking portions 18C of the first louver 18 is more effectively prevented from being visually recognized.

Further, when the first LED 13 is turned on while the second LED 24 is turned off, on the second opposite main surface 225C, light incident on the fourth inclined surface 228B is refracted in the direction corresponding to the third angle θ203, and light incident on the fifth inclined surface 229B is refracted in a direction corresponding to the fourth angle θ204. In the present embodiment, since the fourth angle θ204 of the fifth inclined surface 229B is smaller than the third angle θ203 of the fourth inclined surface 228B, a degree of refraction imparted to the light incident on the fifth inclined surface 229B from the first light guide plate 14 side is smaller than a degree of refraction imparted to the light incident on the fourth inclined surface 228B. As a result, when light incident from the first light guide plate 14 side and refracted by the fifth inclined surface 229B is emitted from the second light guide plate light emission main surface 225B, the light is less likely to travel outside the angle range restricted by the first light blocking portions 18C of the first louver 18.

Further, when the first LED 13 is turned on while the second LED 24 is turned off, on the second opposite main surface 225C, light incident on the fifth inclined surface 229B is refracted in the direction corresponding to the fourth angle θ204, and light incident on the sixth inclined surface 33 is refracted in a direction corresponding to the fifth angle θ5. In the present embodiment, since the fifth angle θ5 of the sixth inclined surface 33 is equal to the fourth angle θ204, degrees of refraction imparted to the respective light beams incident on the fifth inclined surface 229B and the sixth inclined surface 33 become equal to each other and also become smaller than the degree of refraction imparted to the light incident on the fourth inclined surface 228B. As a result, when the respective light beams incident from the first light guide plate 14 side and refracted by the fifth inclined surface 229B and the sixth inclined surface 33 are emitted from the second light guide plate light emission main surface 225B, the light beams are less likely to travel outside the angle range restricted by the first light blocking portions 18C of the first louver 18.

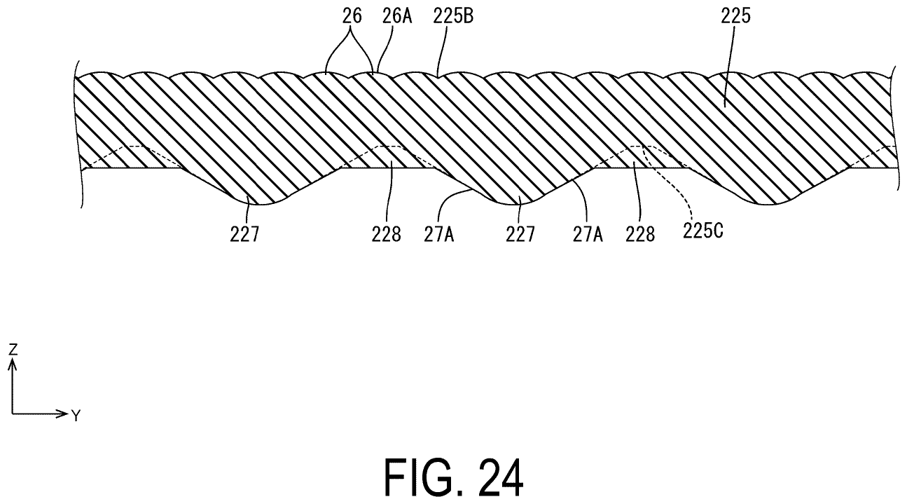

Further, as illustrated in FIG. 24, a fifth light guide plate lens 227 has a width dimension, which is a dimension in the Y-axis direction, that is greater than the width dimension (0.126 mm) of the fifth light guide plate lens 27 described in the first embodiment, and is, for example, approximately 0.165 mm. An array interval of a plurality of the fifth light guide plate lenses 227 arranged along the Y-axis direction (an interval between the apexes of two of the fifth light guide plate lenses 227 arranged along the Y-axis direction) is the same as the array interval of the fifth light guide plate lenses 27 described in the first embodiment, and is, for example, approximately 0.175 mm. Further, an apex angle of the fifth light guide plate lens 227 is smaller than the apex angle (140°) of the fifth light guide plate lens 27 described in the first embodiment, and is, for example, approximately 120°. Here, an occupancy ratio of the width dimension of the fifth light guide plate lens 227 in the array interval is approximately 94% when the ratio is expressed as a percentage, which is obtained by dividing the width dimension (0.165 mm) by the array interval (0.175 mm). As the occupancy ratio of the width dimension of the fifth light guide plate lens 227 in the array interval becomes higher, an occupancy ratio of the sixth light guide plate lenses 228 and the seventh light guide plate lenses 229 in the second opposite main surface 225C of the second light guide plate 225 tends to become lower. On the other hand, an occupancy ratio of the width dimension (0.126 mm) of the fifth light guide plate lens 27 described in the first embodiment in the array interval (0.175 mm) is approximately 72%. Therefore, in the present embodiment, the occupancy ratio of the sixth light guide plate lenses 228 and the seventh light guide plate lenses 229 in the second opposite main surface 225C of the second light guide plate 225 is lower than that in the first embodiment. As a result, when the first LED 13 is turned on while the second LED 24 is turned off, the probability that light from the first louver 18 is refracted by each of the inclined surfaces 33, 228A, 228B, 229A, and 229B is reduced, and thus when the light is emitted from the second light guide plate light emission main surface 225B, the light is less likely to travel outside the angle range restricted by the first light blocking portions 18C of the first louver 18. Note that the fifth light guide plate lens 227 is rounded so that an apex portion thereof forms an arc shape, and the curvature radius thereof is, for example, approximately 0.0875 mm.

Next, Demonstration Experiment 3 was performed in order to acquire knowledge related to how light distribution changes when the third angle θ203 formed by the fourth inclined surface 228B of the sixth light guide plate lens 228 of the second light guide plate 225 with respect to the X-axis direction is changed. In Demonstration Experiment 3, the backlight device 12 having the same configuration as that described before the present paragraph is used except for a configuration of the sixth light guide plate lens 228. In Demonstration Experiment 3, the third angle θ203 of the fourth inclined surface 228B was changed in a range from 60° to 75°. Specifically, in Demonstration Experiment 3, the third angle θ203 of the fourth inclined surface 228B was set to 60°, 65°, 67°, 70°, and 75°. In the backlight device 12 in which the third angle θ203 of the fourth inclined surface 228B was changed in such a manner, brightness of emission light when the first LED 13 was turned on and the second LED 24 was turned off was measured, and a graph regarding light distribution (brightness angle distribution) in the X-axis direction was produced. Moreover, a ratio of light at each angle of −25°, −35°, and −45° in the light distribution in the X-axis direction was calculated. In the calculation, the peak brightness at each of the angles of −25°, −35°, and −45° is divided by the overall peak brightness (relative brightness “1”). Here, the significance of calculating the ratio of light at each of the angles of −25°, −35°, and −45° is to present an index regarding whether or not the side lobe light (light emitted in the range from −80° to −50°) is easily visually recognized. In other words, in order for the side lobe light to be less likely to be visually recognized, it is preferable that the ratio of light at −25° is 5% or less, the ratio of light at −35° is 3% or less, and the ratio of light at −45° is 2.5% or less. In this way, a reference value at which the side lobe light is less likely to be visually recognized tends to become lower as the angle in the X-axis direction in the light distribution increases.

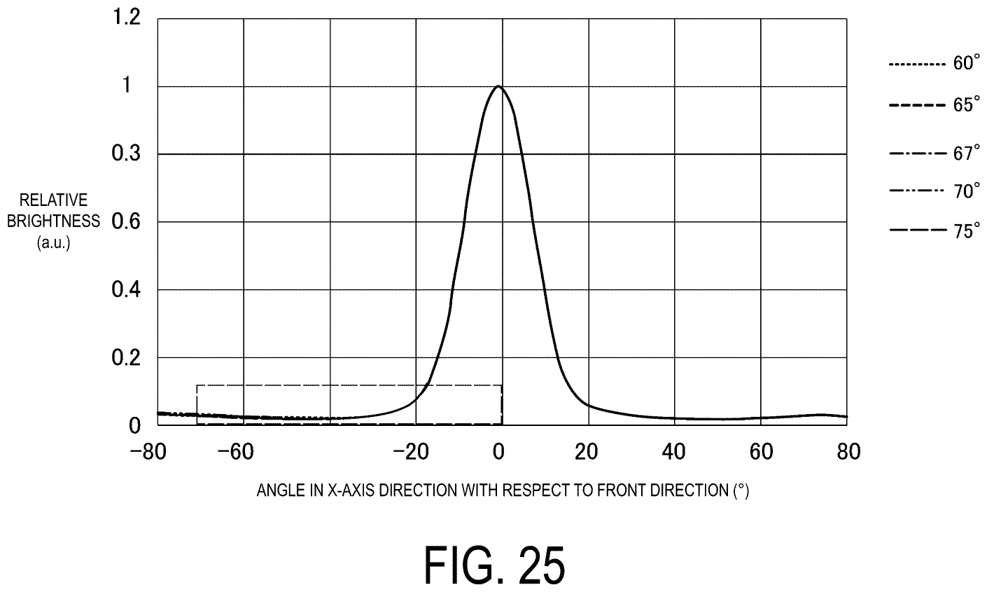

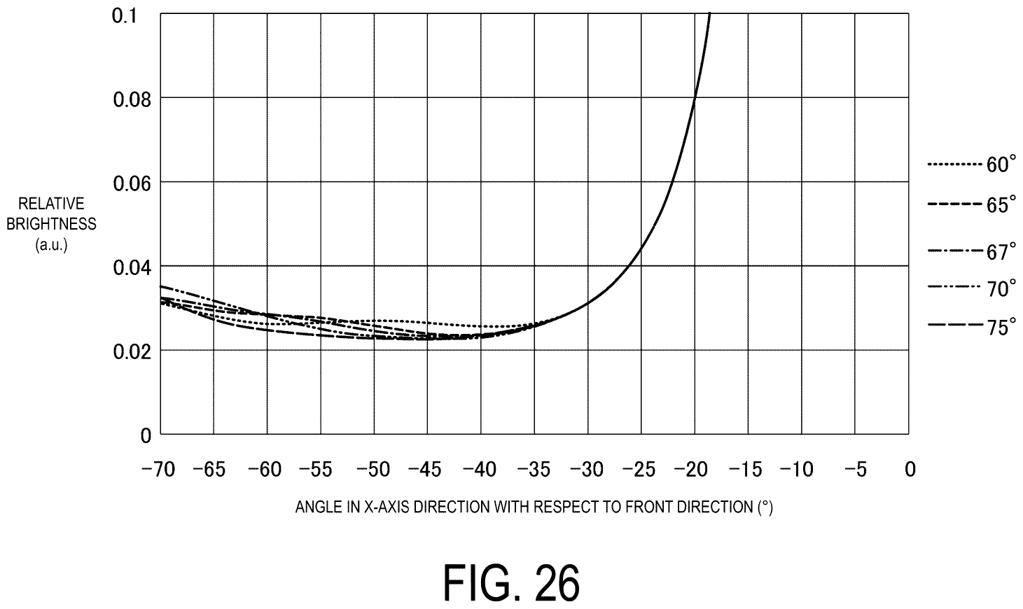

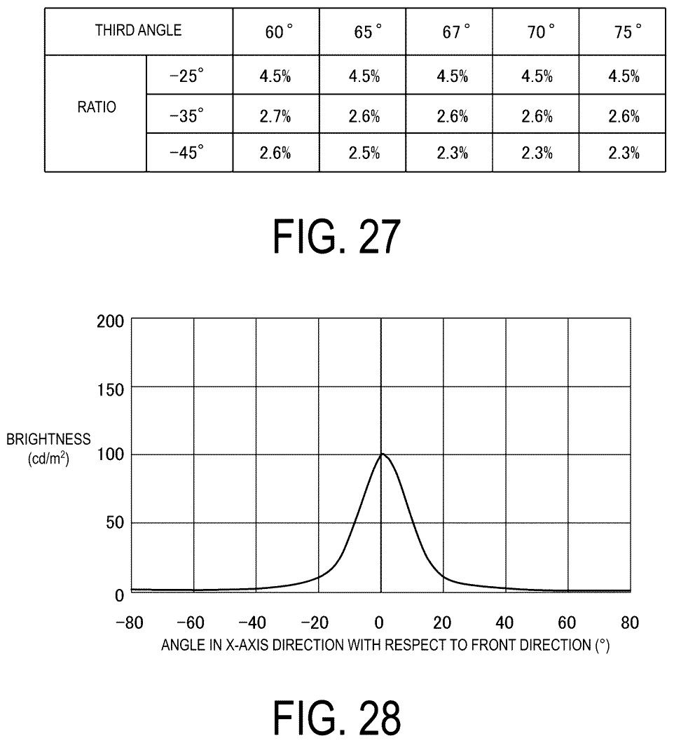

An experimental result of Demonstration Experiment 3 is as shown in FIG. 25 to FIG. 27. FIG. 25 is a graph showing the light distribution when the third angle θ203 of the fourth inclined surface 228B is set to 60°, 65°, 67°, 70°, and 75°. In the graph regarding the light distribution shown in FIG. 25, the horizontal axis is the angle (in units of “°”) in the X-axis direction with respect to the front direction (Z-axis direction), and the vertical axis is relative brightness (no unit). FIG. 26 is an enlarged graph of a range from 0° to −70° in the horizontal axis and a range from 0 to 0.1 in the vertical axis in FIG. 25. Positive and negative symbols provided to the angles in the horizontal axis in FIGS. 25 and 26 have the same meaning as the symbols provided to the horizontal axis in the graph in FIG. 10 described in Demonstration Experiment 1 of the first embodiment. FIG. 27 is a table showing a relationship between the third angle θ203 (in units of “0”) and the ratio (in units of “%”) of light at each of the angles of −25°, −35°, and −45° in the X-axis direction in the light distribution.

The experimental result of Demonstration Experiment 3 will be described. According to FIGS. 25 to 27, when the third angle θ203 of the fourth inclined surface 228B is 60°, the ratios of light at −25° and −35° are their reference values (5% and 3%) or less, respectively, but the ratio of light at −45° is greater than its reference value (2.5%). In contrast, when the third angle θ203 of the fourth inclined surface 228B is 65°, 67°, 70°, and 75°, it can be seen that the ratios of light at −25°, −35°, and −45° are all less than the respective reference values. In particular, when the third angle θ203 of the fourth inclined surface 228B is 65°, the ratio of light at −45° is equal to the reference value (2.5%), whereas when the third angle θ203 of the fourth inclined surface 228B is 67°, 70°, and 75°, the ratio of light at −45° is smaller than the reference value (2.3%). Therefore, it can be said that when the third angle θ203 of the fourth inclined surface 228B is set to 67° or greater, the side lobe light is favorably made less likely to be visually recognized.

Next, in order to validate the advantages of the backlight device 12 and the liquid crystal display device 10 according to the present embodiment, Comparative Experiment 3 similar to Comparative Experiment 1 of the first embodiment was performed. In Comparative Experiment 3, Example 3 described below was used. Example 3 is the backlight device 12 having the same configuration as that described before Demonstration Experiment 3 in which the first angle θ201 of the first inclined surface 228A is 33°, the second angle θ202 of the second inclined surface 229A is 54°, the third angle θ203 of the fourth inclined surface 228B is 67°, the fourth angle θ204 of the fifth inclined surface 229B is 1.4°, and the fifth angle θ5 of the sixth inclined surface 33 is 1.4°. In Comparative Experiment 3, using Example 3, brightness of emission light was measured in each of the case where the first LED 13 was turned on and the second LED 24 was turned off, the case where the second LED 24 was turned on and the first LED 13 was turned off, and the case where both of the first LED 13 and the second LED 24 were turned on, and a graph regarding light distribution (brightness angle distribution) in the X-axis direction was produced.

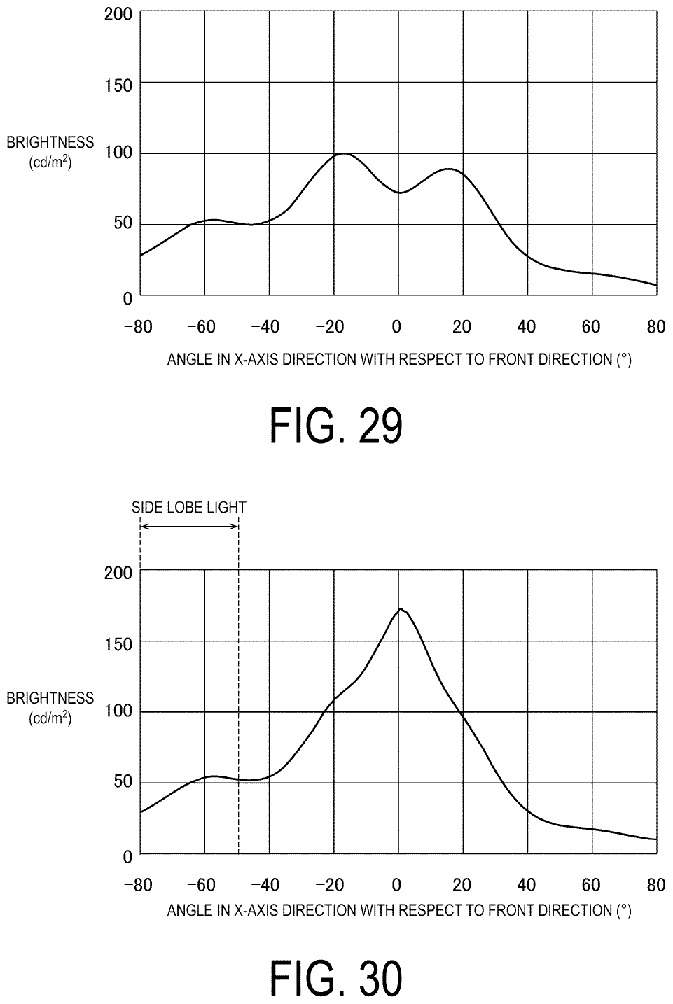

An experimental result on the light distribution in Comparative Experiment 3 is as shown in FIGS. 28 to 30. In graphs regarding the light distribution shown in FIGS. 28 to 30, the horizontal axis indicates the angle (in units of “0”) in the X-axis direction with respect to the front direction (Z-axis direction), and the vertical axis indicates brightness (in units of “cd/m²”). Positive and negative symbols provided to the angles in the horizontal axis in FIGS. 28 to 30 have the same meaning as the symbols provided to the horizontal axis in the graph in FIG. 10 described in Demonstration Experiment 1 of the first embodiment. FIGS. 28 to 30 show the experimental result of Example 3. FIG. 28 shows the light distribution when the first LED 13 is turned on and the second LED 24 is turned off. FIG. 29 shows the light distribution when the second LED 24 is turned on and the first LED 13 is turned off. FIG. 30 shows the light distribution when both of the first LED 13 and the second LED 24 are turned on.

The experimental result of Comparative Experiment 3 will be described while appropriately comparing it with the experimental result of Comparative Experiment 2 (FIGS. 20 to 22). First, according to the light distribution in FIG. 28, which is the experimental result of Example 3, when the first LED 13 is turned on and the second LED 24 is turned off, the peak brightness was at substantially 0°, and the emission angle range was approximately ±10°. This result is substantially the same as the experimental result according to Example 1 of Comparative Experiment 1 (see FIG. 14).

Next, according to the light distribution shown in FIG. 29, which is the experimental result of Example 3, when the second LED 24 is turned on and the first LED 13 is turned off, there are two peak brightnesses in the vicinity of −20° and in the vicinity of +20°. It is inferred that the emission light in the vicinity of −20° is light reflected by the first inclined surface 228A, and the emission light in the vicinity of +20° is light reflected by the second inclined surface 229A. In the light distribution shown in FIG. 29, which is the experimental result of Example 3, the brightness is slightly lower in the range from −40° to +40° than that of the experimental result (see FIG. 21) according to Example 2 of Comparative Experiment 2, and the brightness is lower in the range from −80° to −50° than in the range from −40° to +40°. In particular, in Example 3, the brightness significantly decreases in a range from −80° to −70°.

The light distribution shown in FIG. 30, which is the experimental result of Example 3, is a combination of the light distribution in FIG. 28 and the light distribution in FIG. 29. According to the light distribution shown in FIG. 30, when both the first LED 13 and the second LED 24 are turned on, the peak brightness is present at substantially 0°, and the brightness tends to decrease as the absolute value of the angle increases (as the angle moves away from 0° on the horizontal axis of FIG. 29) over the entire angle range. In the light distribution shown in FIG. 30, which is the experimental result of Example 3, the brightness is slightly lower in the range from −40° to +40° than that of the experimental result (see FIG. 22) according to Example 2 of Comparative Experiment 2, the brightness is lower in the range from −80° to −50° than in the range from −40° to +40°, and in particular, the brightness significantly decreases in the range from −80° to −70°. It is inferred this is because, in Example 3, light having transmitted through the second inclined surface 229A is refracted by the fourth inclined surface 228B having the third angle θ203 of 67° and most of the light is totally reflected by the second light guide plate light emission main surface 225B, so that the side lobe light emitted in the range from −80° to −50° is reduced. In addition, it is inferred that, since the fourth angle θ204 of the fifth inclined surface 229B and the fifth angle θ5 of the sixth inclined surface 33 are both approximately 1.4°, which is a value close to 0°, when the light from the first louver 18 is incident on the second opposite main surface 225C of the second light guide plate 225, a refraction effect provided by the fifth inclined surface 229B and the sixth inclined surface 33 is very small, which also contributes to the reduction of the side lobe light emitted in the range from −80° to −50°. Further, it is inferred that the fact that the occupancy ratio of the width dimension of the fifth light guide plate lens 227 in the array interval is as high as approximately 94% also contributes to the reduction of the side lobe light. Note that the reason why the brightness is slightly lower in the range from −40° to +40° is presumed to be that the fourth angle θ204 of the fifth inclined surface 229B is approximately 1.4°, which is extremely small compared to the third angle θ203 of the fourth inclined surface 228B, and thus, light traveling from the side opposite to the second LED 24 side to the second LED 24 side in the X-axis direction inside the second light guide plate 225 is less likely to be raised by the fifth inclined surface 229B.

As described above, according to the present embodiment, the third angle θ203 of the fourth inclined surface 228B is 67° or greater. In the case where the first LED 13 is turned on while the second LED 24 is turned off, when the light emitted from the first light guide plate light emission main surface 14B of the first light guide plate 14 transmits through the first light-transmitting portion 18D of the first louver 18, the light is incident on the first inclined surface 228A, the second inclined surface 229A, and the fourth inclined surface 228B provided on the second opposite main surface 225C of the second light guide plate 225. Of the light, the light incident on the fourth inclined surface 228B is refracted in the direction corresponding to the third angle θ203. Then, when the third angle θ203 is 67° or greater, a ratio of the light traveling toward the side opposite to the second LED 24 side in the first direction in the light emitted from the second light guide plate light emission main surface 225B can be reduced as compared to when the third angle θ203 is 65° or greater and less than 67°. In particular, of the light traveling toward the side opposite to the second LED 24 side in the first direction, a ratio of the light traveling in the direction of 45° with respect to the first direction in the light emitted from the second light guide plate light emission main surface 225B can be made 2.3% or less. As a result, the light emitted outside the angle range restricted by the first light blocking portions 18C of the first louver 18 is more effectively prevented from being visually recognized.

Further, the third inclined surface 231 includes the fourth inclined surface 228B disposed so as to face the second inclined surface 229A with an interval therebetween and the fifth inclined surface 229B disposed so as to face the first inclined surface 228A with an interval therebetween, and the fourth angle θ204, which is an angle with respect to the first direction, of the fifth inclined surface 229B is smaller than the third angle θ203, which is an angle with respect to the first direction, of the fourth inclined surface 228B. In the case where the second LED 24 is turned on while the first LED 13 is turned off, when the light emitted from the first light guide plate light emission main surface 14B of the first light guide plate 14 transmits through the first light-transmitting portions 18D of the first louver 18, the light is incident on the first inclined surface 228A, the second inclined surface 229A, the fourth inclined surface 228B, and the fifth inclined surface 229B provided on the second opposite main surface 225C of the second light guide plate 225. Of the light, the light incident on the fourth inclined surface 228B is refracted in the direction corresponding to the third angle θ203, and the light incident on the fifth inclined surface 229B is refracted in the direction corresponding to the fourth angle θ204. Here, since the fourth angle θ204 of the fifth inclined surface 229B is smaller than the third angle θ203 of the fourth inclined surface 228B, the degree of refraction imparted to the light incident on the fifth inclined surface 229B from the first light guide plate 14 side is smaller than the degree of refraction imparted to the light incident on the fourth inclined surface 228B. As a result, when light incident from the first light guide plate 14 side and refracted by the fifth inclined surface 229B is emitted from the second light guide plate light emission main surface 225B, the light is less likely to travel outside the angle range restricted by the first light blocking portions 18C of the first louver 18.

Further, the first inclined surface 228A and the fourth inclined surface 228B are disposed with an interval therebetween in the first direction, the third inclined surface 231 includes the sixth inclined surface 33 located between the first inclined surface 228A and the fourth inclined surface 228B, and the fifth angle θ5, which is an angle with respect to the first direction, of the sixth inclined surface 33 is equal to the fourth angle θ204. When the first LED 13 is turned on while the second LED 24 is turned off, degrees of refraction imparted to respective light beams incident on the fifth inclined surface 229B and the sixth inclined surface 33 becomes equal to each other and smaller than the degree of refraction imparted to the light incident on the fourth inclined surface 228B. As a result, when the respective light beams incident from the first light guide plate 14 side and refracted by the fifth inclined surface 229B and the sixth inclined surface 33 are emitted from the second light guide plate light emission main surface 225B, the light beams are less likely to travel outside the angle range restricted by the first light blocking portions 18C of the first louver 18.

### OTHER EMBODIMENTS

The techniques disclosed herein are not limited to the embodiments described above and illustrated in the drawings, and the following embodiments, for example, are also included within the technical scope.
(1) Specific numerical values of the first angles θ1, 0101, and 0201, the second angles θ2, 0102, and 0202, the third angles θ3, 0103, and 0203, the fourth angles θ4, 0104, and θ204, and the fifth angle θ5 may be changed as appropriate in addition to those described above.
(2) In the configuration described in the first embodiment, the third plane 32 may be omitted.
(3) In the configurations described in the first and second embodiments, the first plane 28C and the second plane 29C may be omitted.
(4) In the configurations described in the second and third embodiments, the third plane 32 may be provided.
(5) In the configuration described in the third embodiment, the third angle θ203 may be equal to the fourth angle θ204. Further, in the configuration described in the third embodiment, the fourth angle θ204 may be equal to the third angle θ203.
(6) In the configuration described in the third embodiment, the fourth angle θ204 and the fifth angle θ5 may be different from each other.
(7) In the configuration described in the third embodiment, the first plane 28C and the second plane 29C may be provided.
(8) In the configuration described in the third embodiment, a plane may be provided instead of the sixth inclined surface 33.
(9) In the configuration described in the third embodiment, a plane may be provided instead of the fifth inclined surface 229B.
(10) Specific arrangements of the sixth light guide plate lenses 28, 128, and 228 and the seventh light guide plate lenses 29, 129, and 229 may be changed as appropriate. For example, a plurality of one of the sixth light guide plate lenses 28, 128, and 228 and a plurality of one of the seventh light guide plate lenses 29, 129, and 229 may be alternately arrayed side by side in an order in which the plurality of one of the sixth light guide plate lenses 28, 128, and 228 are continuously disposed and then the plurality of one of the seventh light guide plate lenses 29, 129, and 229 are continuously disposed.
(11) Specific numerical values of the array pitches P1, P2, P201, and P202 of the sixth light guide plate lenses 28, 128, and 228 and the seventh light guide plate lenses 29, 129, and 229 in the X-axis direction may be changed as appropriate other than those described above.
(12) Specific numerical values of the width dimensions W2 to A8 and the height dimensions H2, H3, H202, and H203 of the inclined surfaces and the planes provided at the sixth light guide plate lenses 28, 128, and 228 and the seventh light guide plate lenses 29,129, and 229 may be changed as appropriate in addition to those described above.
(13) Specific materials used in the first light guide plate 14 and the second light guide plates 25, 125, and 225 can be changed as appropriate.
(14) Specific numerical values of the contact angle, the inclination angle, and the like of each of the light guide plate lenses 21 to 23 provided in the first light guide plate 14 can be changed as appropriate.
(15) A positional relationship between the second LED 24 and each of the second light guide plates 25, 125, and 225 in the X-axis direction may be the same as a positional relationship between the first LED 13 and the first light guide plate 14 in the X-axis direction. In other words, the first LED 13 and the second LED 24 may be disposed on the same side in the X-axis direction.
(16) One or both of the first light guide plate lens 21 and the second light guide plate lens 22 provided in the first light guide plate 14 can also be omitted.
(17) Specific numerical values of the contact angle of the fourth light guide plate lens 26 provided in each of the second light guide plates 25, 125, and 225, the apex angle of each of the fifth light guide plate lenses 27 and 227, and the like can be changed as appropriate.
(18) One or both of the fourth light guide plate lens 26 and the fifth light guide plate lens 27 and 227 provided in the second light guide plate 25, 125, and 225 can also be omitted.
(19) The thickness of the first light guide plate 14 may be configured to decrease with increasing distance from the first LED 13, and the first opposite main surface 14C may be configured to be inclined.
(20) The thickness of each of the second light guide plates 25, 125, and 225 may be configured to decrease with increasing distance from the second LED 24, and the second opposite main surfaces 25C, 125C, and 225C may be configured to be inclined.
(21) Specific numerical values of the inclination angle and the apex angle of each of the prism inclined surfaces 16B1, 16B2, 17B1, and 17B2 of each of the prisms 16B and 17B provided in each of the prism sheets 16 and 17 can be changed as appropriate. A specific material used in each of the base materials 16A and 17A of each of the prism sheets 16 and 17 can be changed as appropriate. Similarly, a specific material used in each of the prisms 16B and 17B can also be changed as appropriate.
(22) A specific cross-sectional shape of each of the prisms 16B and 17B provided in each of the prism sheets 16 and 17 can be changed as appropriate. In that case, for example, any one of the prism inclined surfaces 16B1, 16B2, 17B1, and 17B2 in each of the prisms 16B and 17B may have a bent shape so as to have a plurality of inclination angles.
(23) In the first louver 18, a specific numerical value of the ratio (tan 0) obtained by dividing the width by the height of the first light-transmitting portion 18D can be changed as appropriate from tan 10°, and can be, for example, tan 12.5°, tan 15°, tan 17.5°, and the like.
(24) The second louver 30 can also be omitted.
(25) A light source such as an organic electro luminescence (EL) may be used instead of the first LED 13 and the second LED 24.
(26) A reflective polarizing sheet instead of a polarizer may be attached to the main surface on the back side (outer side) of the array substrate constituting the liquid crystal panel 11. The reflective polarizing sheet includes a polarization layer having a specific polarization axis (transmission axis), a multilayer film in which layers having mutually different refractive indices are alternately layered, a protection layer, and the like. The polarization layer has a polarization axis and an absorption axis orthogonal to the polarization axis, so that linearly polarized light parallel to the polarization axis can be selectively transmitted and circularly polarized light can be converted to linearly polarized light along the polarization axis. The polarization axis of the polarization layer has an orthogonal relationship to the polarization axis of the polarizer attached to the main surface at the outer side of the CF substrate. The multilayer film has a multilayer structure, and has a reflection characteristic that the reflectivity for the s-waves included in light is generally higher than the reflectivity for the p-waves. By the reflective polarizing sheet including the multilayer film, the reflective polarizing sheet can reflect the s-waves, which are originally to be absorbed by the polarization layer, toward the back side to allow the s-waves to be reused, and thus can improve the light usage efficiency (and then, the brightness).
(27) Instead of the first prism sheet 16 and the second prism sheet 17, a prism sheet with a prism provided on the light incident main surface side can also be used. The prism sheet has a configuration in which the light incident main surface faces the first light guide plate light emission main surface 14B of the first light guide plate 14, the light emission main surface is disposed so as to face the first light incident main surface 18A of the first louver 18, and a plurality of the prisms are provided side by side along the X-axis direction on the light incident main surface. Even when such a prism sheet is used, light having less side lobe light can be supplied to the first louver 18, and the amount of transmitted light of the first light-transmitting portion 18D can be sufficiently secured.
(28) The liquid crystal display device 10 for vehicle application may be installed at a position other than in front of the front passenger seat of the passenger vehicle. For example, the liquid crystal display device 10 may be installed at a position between the front passenger seat and the driver's seat, and the like. Since the angle range of a required viewing angle is also changed due to the change in the arrangement of the liquid crystal display device 10, in accordance with the change, each of the configurations of the first louvers 18, the sixth light guide plate lenses 28, 128, and 228, the seventh light guide plate lenses 29, 129, and 229, and the like may be changed.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An illumination device comprising:
a first light source;
a first light guide plate, at least a part of an outer peripheral end surface of the first light guide plate being a first end surface facing the first light source and on which light is incident, one of main surfaces of the first light guide plate being a first main surface configured to emit light and the other of the main surfaces being a second main surface;
a first sheet, one of main surfaces of the first sheet being a third main surface facing the first main surface and on which light is incident, and the other of the main surfaces being a fourth main surface configured to emit light;
a second light source; and
a second light guide plate, at least a part of an outer peripheral end surface of the second light guide plate being a second end surface facing the second light source and on which light is incident, one of main surfaces of the second light guide plate being a fifth main surface configured to emit light, and the other of the main surfaces being a sixth main surface disposed facing the fourth main surface,
wherein the first sheet at least includes two first light blocking portions and a first light-transmitting portion, the two first light blocking portions being disposed with an interval therebetween in a first direction including a direction from the first light source toward the first light guide plate and being configured to block light, the first light-transmitting portion being disposed between the two first light blocking portions and configured to transmit light,
the sixth main surface of the second light guide plate includes a first inclined surface and a second inclined surface, the first inclined surface and the second inclined surface having an inclination rising from a side opposite to a side of the second light source toward the side of the second light source in the first direction,
an angle of the first inclined surface with respect to the first direction is a first angle greater than 27°, and
an angle of the second inclined surface with respect to the first direction is a second angle greater than the first angle and smaller than 58°.

2. The illumination device according to claim 1,
wherein the sixth main surface of the second light guide plate includes a third inclined surface having an inclination rising from the side of the second light source toward the side opposite to the side of the second light source in the first direction.

3. The illumination device according to claim 2,
wherein the third inclined surface includes a fourth inclined surface disposed facing the second inclined surface with an interval therebetween, and
an angle of the fourth inclined surface with respect to the first direction is a third angle equal to or greater than 40°.

4. The illumination device according to claim 3,
wherein the third angle of the fourth inclined surface is equal to or greater than 65°.

5. The illumination device according to claim 3,
wherein the third angle of the fourth inclined surface is equal to or greater than 67°.

6. The illumination device according to claim 2,
wherein the third inclined surface includes a fourth inclined surface disposed facing the second inclined surface with an interval therebetween and a fifth inclined surface disposed facing the first inclined surface with an interval therebetween, and
an angle of the fifth inclined surface with respect to the first direction is a fourth angle equal to a third angle, the third angle being an angle of the fourth inclined surface with respect to the first direction.

7. The illumination device according to claim 2,
wherein the third inclined surface includes a fourth inclined surface disposed facing the second inclined surface with an interval therebetween and a fifth inclined surface disposed facing the first inclined surface with an interval therebetween, and
an angle of the fifth inclined surface with respect to the first direction is a fourth angle smaller than a third angle, the third angle being an angle of the fourth inclined surface with respect to the first direction.

8. The illumination device according to claim 7,
wherein the first inclined surface and the fourth inclined surface are disposed with an interval therebetween in the first direction,
the third inclined surface includes a sixth inclined surface located between the first inclined surface and the fourth inclined surface, and
an angle of the sixth inclined surface with respect to the first direction is a fifth angle equal to the fourth angle.

9. A display device comprising:
the illumination device according to claim 1; and
a display panel configured to perform display using light from the illumination device.
